(19) United States
(12) Patent Application Publication
(10) Pub. No.: US 2024/0067779 A1
(43) Pub. Date: Feb. 29, 2024

(54) METALLOPOLYMERS AND ICLICK SYNTHESIS THEREOF

(71) Applicant: UNIVERSITY OF FLORIDA RESEARCH FOUNDATION, INCORPORATED, Gainesville, FL (US)

(72) Inventors: Christopher Beto, Edwards Afb, CA (US); Kirk S. Schanze, San Antonio, TX (US); Adam S. Veige, Gainesville, FL (US); Yajing Yang, San Antonio, TX (US)

(73) Assignee: UNIVERSITY OF TEXAS SAN ANTONIO, Austin, TX (US)

(21) Appl. No.: 18/241,443

(22) Filed: Sep. 1, 2023

Related U.S. Application Data
(63) Continuation-in-part of application No. PCT/US22/17433, filed on Feb. 23, 2022.
(60) Provisional application No. 63/231,849, filed on Aug. 11, 2021.
(60) Provisional application No. 63/155,120, filed on Mar. 1, 2021.

(51) Int. Cl. C08G 79/00

(52) U.S. Cl. CPC C08G 79/00

(57) ABSTRACT

Provided herein are various metallopolymers and methods of making the same.

### CROSS-REFERENCE TO RELATED APPLICATIONS

This application is a continuation-in-part of PCT/US22/17433, filed Feb. 23, 2022, which claims the benefit under 35 U.S.C. § 119 of U.S. Provisional Patent Application Nos. 63/155120, filed Mar. 1, 2021, and 63/231849, filed Aug. 11, 2021, the entire disclosures of which are incorporated herein by reference.

### STATEMENT OF US GOVERNMENT SUPPORT

This invention was made with government support under Grant Nos. DE-SC0020008 and DE-SC0016526, awarded by the Department of Energy. The government has certain rights in the invention.

### BACKGROUND

Metallopolymers have the potential to be next-generation materials for the energy sector, information storage, and materials synthesis. Uniquely, transition metal chemistry marries polymer science in these hybrid materials wherein the metal imparts new properties unimaginable for organic polymers alone. There is a need for new strategies to construct well-defined and rationally-designed metallopolymers with complete understanding of their optoelectronic and redox properties are necessary if their full potential is to be realized.

### SUMMARY

Provided herein are metallopolymers comprising a plurality of monomer units, each monomer unit comprising: (a) a first transition metal; (b) a first 1,2,3-triazole substituted at one or more of the 1, 4, and 5 positions and the first 1,2,3-triazole conjugated directly or indirectly to the first transition metal; and (c) a first N-heterocyclic carbene (NHC) coordinated to the first transition metal.

Also provided herein are methods of preparing a metallopolymer according to any one of claims 1-33, comprising: admixing an azide-containing compound and an alkyne-containing compound to form the metallopolymer according to any one of claims 1-33, wherein one or both of the azide-containing compound and the alkyne-containing compound further comprises a transition metal and one or both of the azide-containing compound and the alkyne-containing compound further comprises an N-heterocyclic carbene.

Also provided herein are metallopolymers having a structure of formula (IIIa) or (IIIb):

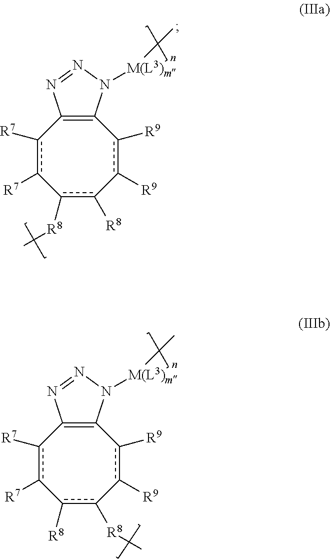

wherein: the dashed lines indicate optional double bonds; each L³ is independently selected from a phosphine, a phosphite, a phosphonite, a phosphinite, an amine, an amide, an imine, an alkoxy, an aryloxy, an ether, a thioether, an alkylthio, an arylthio, and a five- or six-membered monocyclic group having 1 to 3 ring heteroatoms selected from O, N, or S; each R⁷ is independently selected from H, C₁₋₁₀alkyl, C₅-C₈cycloalkyl, and Ar³, or both R⁷, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S; each R⁸ is independently selected from H, C₁₋₁₀alkyl, C₅-C₈cycloalkyl, and Ar³, or both R⁸, taken together with the carbon atoms to which they are attached, form an aryl, heteroaryl, or 5-7 membered cycloalkyl, or 5-7 membered heterocycloalkyl comprising from 1 to 3 ring heteroatoms selected from O, N, and S; each R⁹ is independently selected from H, C₁₋₁₀alkyl, C₅-C₈cycloalkyl, and Ar³, or both R⁹, taken together with the carbon atoms to which they are attached, form an aryl, heteroaryl, or 5-7 membered cycloalkyl, or 5-7 membered heterocycloalkyl comprising from 1 to 3 ring heteroatoms selected from O, N, and S; n is 10 or more; m″ is 1, 2, 3, or 4; M is a transition metal; and each Ar³ is independently selected from C₆-C₂₂ aryl and a 5-12 membered heteroaryl comprising from 1 to 3 ring heteroatoms selected from O, N, and S.

Also provided herein are methods of preparing a metallopolymer according to any one of claims 42-54, comprising: admixing an azide-containing compound and an alkyne-containing compound to form the metallopolymer according to any one of claims 42-54, wherein one or both of the azide-containing compound and alkyne-containing compound further comprise a transition metal.

Also provided herein are metallopolymers having a structure of formula (IX), (X), (XII) or (XIII):

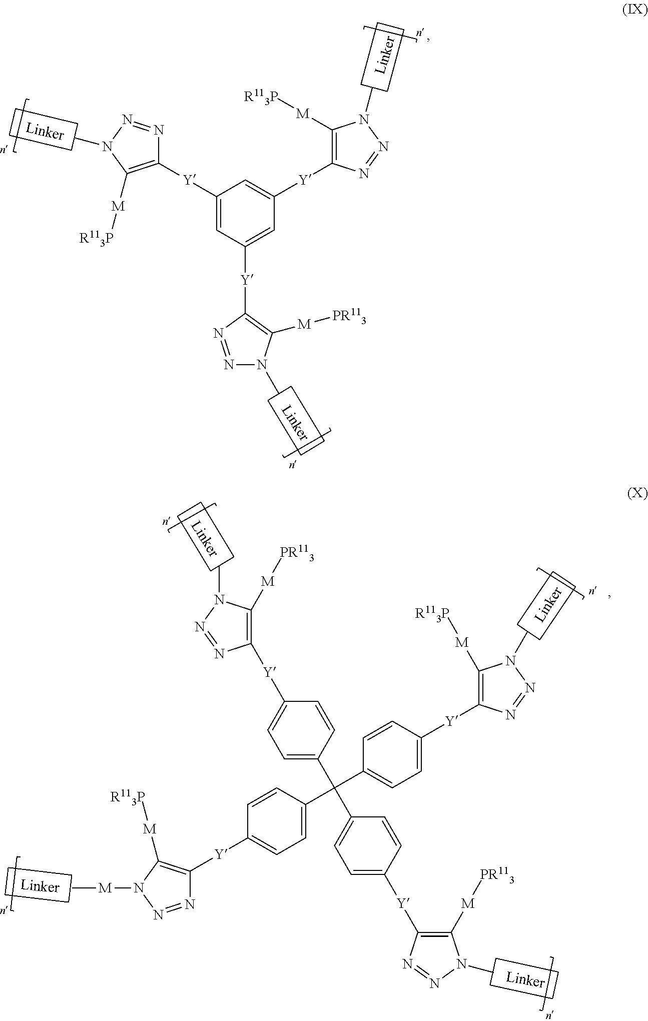

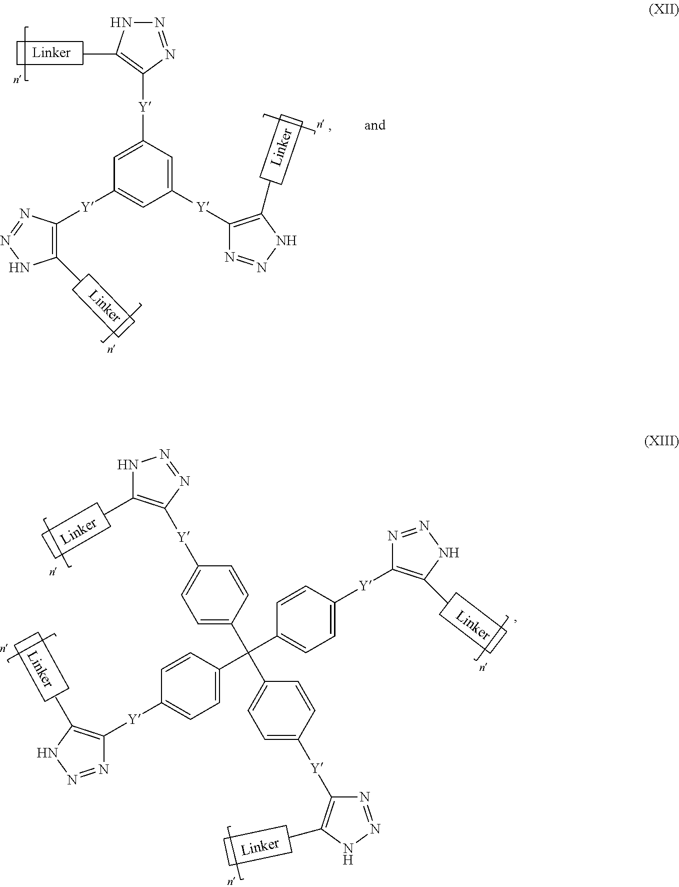

wherein: each Linker [symbol] has a structure:

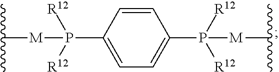

each M is a transition metal; each R¹¹ is independently selected from H, C₁₋₁₀alkyl, C₅-C₈cycloalkyl, Ar³, heteroaryl, and 5-7 membered heterocycloalkyl comprising from 1 to 3 ring heteroatoms selected from O, N, and S; each R¹² is independently selected from H, C₁₋₁₀alkyl, C₅-C₈cycloalkyl, Ar³, and 5-7 membered heterocycloalkyl comprising from 1 to 3 ring heteroatoms selected from O, N, and S; each n′ is an integer; each Y′ is absent or independently selected from C₁₋₁₀alkyl and Ar³; and each Ar³ is independently selected from C₆-C₂₂aryl and a 5-12 membered heteroaryl comprising from 1 to 3 ring heteroatoms selected from O, N, and S.

Also provided herein are methods of preparing a metallopolymer having a structure according to formula (IX), (X), (XII), or (XIII), comprising: admixing a compound of formula (IXa), (Xa), (XIIa), or (XIIIa) with a compound of formula (XI):

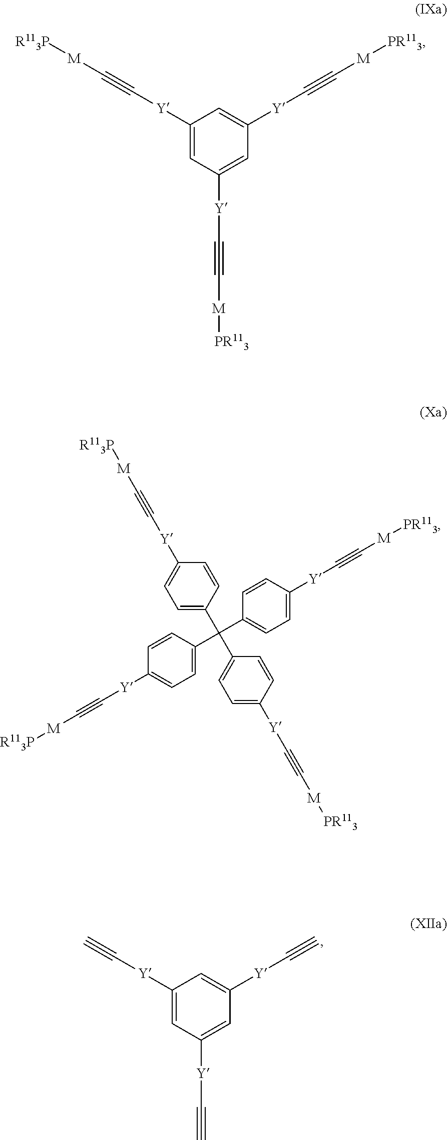

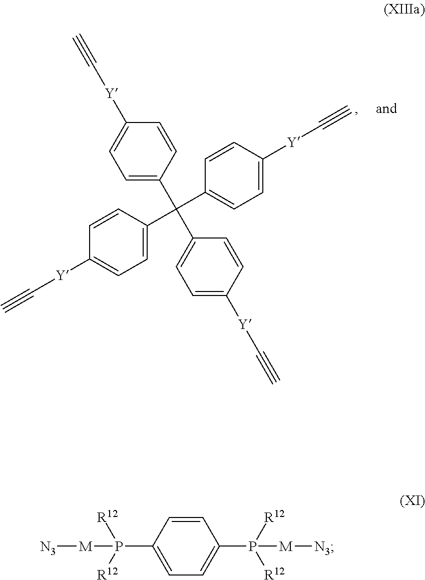

wherein each M is a transition metal; each R¹¹ is independently selected from H, C₁₋₁₀alkyl, C₅-C₈cycloalkyl, Ar³, heteroaryl, and 5-7 membered heterocycloalkyl comprising from 1 to 3 ring heteroatoms selected from O, N, and S; each R¹² is independently selected from H, C₁₋₁₀alkyl, C₅-C₈cycloalkyl, Ar³, and 5-7 membered heterocycloalkyl comprising from 1 to 3 ring heteroatoms selected from O, N, and S; each Y′ is absent or independently selected from C₁₋₁₀alkyl and Ar³; and each Ar³ is independently selected from C₆-C₂₂aryl and a 5-12 membered heteroaryl comprising from 1 to 3 ring heteroatoms selected from O, N, and S.

### BRIEF DESCRIPTION OF THE DRAWINGS

FIG. 1 shows N₂ adsorption-desorption isotherms of a compound of the disclosure, 5-AuPEt₃.

### DETAILED DESCRIPTION

Provided herein are metallopolymers having a structure represented by formula (I), (IIa), (IIb), (IIIa), (IIIb), (IV), (V), (VI), (VII), (IX), (X), (XII), and/or (XIII) and methods of making the metallopolymers of the disclosure. As is typical in the art, in the chemical structures provided herein, hydrogen atoms may not be shown for clarity/simplicity and will be understood to be present where needed for the atoms of the structure to have complete valence.

Modifications and other embodiments will come to mind to one skilled in the art to which the disclosed compounds and methods pertain to having the benefit of the teachings presented herein. Therefore, it is to be understood that the disclosures are not to be limited to the specific embodiments disclosed and that modifications and other embodiments are intended to be included within the scope of the appended claims.

It is also to be understood that the terminology used herein is for the purpose of describing particular aspects only and is not intended to be limiting. As used in the specification and in the claims, the term “comprising” can include the aspect of “consisting of.” Unless defined otherwise, all technical and scientific terms used herein have the same meaning as commonly understood by one of ordinary skill in the art to which the disclosed compositions and methods belong. In this specification and in the claims which follow, reference will be made to a number of terms which shall be defined herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

### Metallopolymers

The disclosure provides metallopolymers comprising a plurality of monomer units, wherein each monomer unit comprises (a) a first transition metal; (b) a first 1,2,3-triazole substituted at one or more of the 1, 4, and 5 positions and the first 1,2,3-triazole is conjugated directly or indirectly to the first transition metal; and, (c) a first N-heterocyclic carbene (NHC) coordinated to the first transition metal. The 1,4,5 positions and the 1,2,3 positions of the triazole are determined based on International Union of Pure and Applied Chemistry (IUPAC) nomenclature at the date of filing, well-known by one of ordinary skill in the art.

The term “Click reaction” refers to a class of reactions well known to one of ordinary skill in the art, one example of which is a reaction between an azide and an alkyne to form a 1,2,3-triazole. In general, the metallopolymers of the disclosure can be prepared by an inorganic “Click” reaction, referred to herein as an “iClick reaction.” The “iClick reaction” of the disclosure refers to a 1,3-dipolar cycloaddition involving one or more metals. The 1,3-dipolar cycloaddition combines an azide complex and an alkyne complex to form a 1,2,3-triazole, wherein the azide complex and/or the alkyne complex is coordinated to one or more metal-ions, resulting in the formation of a metallopolymer of the disclosure. In embodiments, the metallopolymers of the disclosure can include a 1,4,5-substituted 1,2,3-triazole resulting from an iClick reaction. In embodiments, the iClick reaction can result in a 1,5-substituted 1,2,3-triazole, or a 1,4-substituted 1,2,3-triazole. The selectivity towards 1,4- or 1,5-addition depends upon the metal or ions and other substituents on the acetylide, in addition to whether the reaction employs copper(I) as a catalyst.

Over the past few decades intense focus has centered on the preparation of organic polymers of various properties using the “organic” azide-alkyne cycloaddition reaction, without a metal atom. Breaking this mold and approach, metallopolymers via iClick were successfully synthesized for the first time (Veige et al., Chem. Commun. 2017, 53, 9934-9937; Veige et al., Cu-catalyzed azide-Pt-acetylide cycloaddition: progress towards a conjugated metallopolymer via iClick. Organometallics 2018, in revision) using PR₃ substituted Pt(II) complexes. However, the conjugation length and light emission properties of these early metallopolymers were somewhat lackluster. In embodiments, the metallopolymers of the disclosure advantageously include N-heterocyclic carbene (NHC) ligands instead of PR₃ ligands. It was found that the strong σ-donating capacity of NHC ligands bound to Pt(II) can advantageously elevate the platinum-centered d-d states to higher energy, reducing the probability of thermal activation which leads to quenching or suppression of the emission efficiency. Additionally, Pt(II) advantageously can adopt a square planar geometry, allowing Pt(II) complexes to exhibit higher energy d-d states relative to similar octahedral complexes such as iridium(III). As a consequence, Pt(II)-NHC complexes can exhibit interesting luminescence properties. For example, substituting PBu₃ ligands in Pt(II) complexes for NHC ligands can result in a NHC-Pt-acetylide complex that has decidedly improved photophysical properties, relative to the complex including the PBu₃ ligands. Square planar Pt(II)-NHC complexes can have cis or trans configurations. Previous reports detail the photophysical properties of cis-Pt(II)-NHC complexes featuring bidentate and tridentate cyclometalating ligands that tune their photophysical and electronic properties (Fuertes et al., Inorg. Chem. 2017, 56, 4829-4839; Ko et al., Dalton Trans. 2015, 44, 8433-8443). Under-studied however, are the trans-NHC isomers (Juvenal et al., ACS Omega 2017, 2, 7433-7443; Winkel et al., Dalton Trans. 2014, 43, 17712-17720). Part of the disclosure herein takes advantage of the high quantum efficiencies of Pt(II)-NHC luminescence by incorporating them into iClick metallopolymers as trans-stereoisomers.

The first transition metal can generally be any transition metal, i.e., as found in groups 3 to 12 of the periodic table. In embodiments, the first transition metal is selected from the group of: Au, Pt, Rh, Pd, Ni, Ru, Co, Fe, Ir, W, Re, and Ag. In embodiments, the first transition metal is Pt, Rh, Pd, or Ni. In embodiments, the first transition metal is Pt. In embodiments, the first transition metal is Rh.

In embodiments, each monomer unit of the metallopolymer of the disclosure can further include a second transition metal. In embodiments, the second transition metal is selected from the group of: Au, Pt, Rh, Pd, Ni, Ru, Co, Fe, Ir, W, Re, and Ag. In embodiments, the second transition metal is Pt, Rh, Pd, or Ni. In embodiments, the second transition metal is Pt. In embodiments, the second transition metal is Rh. In embodiments, the first transition metal and the second transition metal are the same transition metal. In embodiments, the first transition metal and the second transition metal are the same transition metal in the same oxidation state. In embodiments, the first transition metal and the second transition metal are the same transition metal, and, the first transition metal has a different oxidation state than the second transition metal. In embodiments, the first transition metal and the second transition metal are different transition metals. In embodiments, the first transition metal and the second transition metal are different transition metals in the same oxidation state. In embodiments, the first transition metal and the second transition metal are different transition metals, and, the first transition metal has a different oxidation state than the second transition metal.

In general, each monomer unit includes a first 1,2,3-triazole substituted at one or more of the 1, 4, and 5 positions and the first 1,2,3-triazole is conjugated directly or indirectly to the first transition metal. As used herein, the term “conjugated directly or indirectly” refers to (i) a 1,2,3-triazole bonded directly to the first transition metal (i.e., conjugated directly), or (ii) a 1,2,3-triazole is bonded to an organic linker that is in turn bonded to the metal (i.e., conjugated indirectly). The organic linker, when present, is not necessarily limited and can be determined to be suitable by one of ordinary skill in the art. For example, the organic linker can be a C₂alkynyl, or a C₂alkynyl-Ph. In embodiments, the first 1,2,3-triazole is conjugated directly to the first transition metal. In embodiments, the first 1,2,3-triazole is conjugated indirectly to the first transition metal.

In embodiments, each monomer unit further comprises a second 1,2,3-triazole conjugated directly or indirectly to the first transition metal or the second transition metal. In embodiments, the second 1,2,3-triazole is conjugated directly to the first transition metal. In embodiments, the second 1,2,3-triazole is conjugated indirectly to the first transition metal. In embodiments, the second 1,2,3-triazole is conjugated directly to the second transition metal. In embodiments, the second 1,2,3-triazole is conjugated indirectly to the second transition metal. In embodiments, the second 1,2,3-triazole is substituted at one or more of the 1, 4, and 5 positions.

In general, the first N-heterocyclic carbene coordinated to the first transition metal is not necessarily limited. As described above, the NHC can affect the energy level of the metal-centered d-d states, which in turn can affect the luminescence properties of the complex. Accordingly, the NHC can be selected to provide a metallopolymer having a desired luminescence property. N-heterocyclic carbenes have not been used before in metallopolymers. In embodiments, each monomer unit further comprises a second NHC coordinated to the first transition metal.

In embodiments wherein each monomer unit comprises a second transition metal, the second transition metal can have at least one N-heterocyclic carbene coordinated to it. In embodiments, the second transition metal has two N-heterocyclic carbenes coordinated to it.

In embodiments, each N-heterocyclic carbene of the disclosure can be independently selected from the group of:

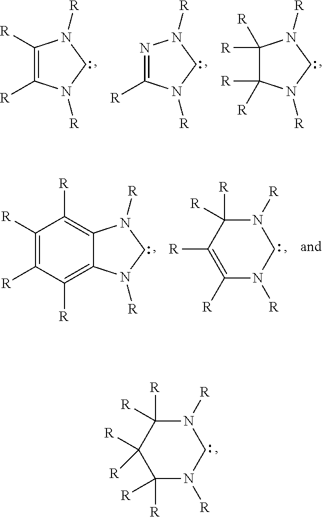

wherein, each R group is independently selected from the group of: H, C₁-C₂₀alkyl, C₄-C₁₅cycloalkyl, C₂-C₂₀alkenyl, C₆-C₂₀aryl, C₁-C₂₀alkoxy, and C₆-C₂₀aryloxy. In embodiments, at least one NHC is

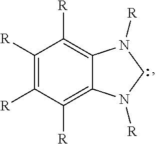

wherein each R is independently H or C₁₋₅alkyl. In embodiments, each NHC is

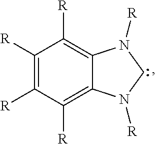

wherein each R is independently H or C₁₋₅alkyl. In embodiments, each NHC is

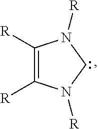

wherein each R is independently H or C₁₋₅alkyl. In embodiments, at least one NHC is

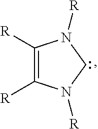

wherein each R is independently H or C₁₋₅alkyl. In embodiments, each NHC is,

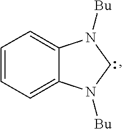

wherein Bu refers to n-butyl. In embodiments, each NHC is

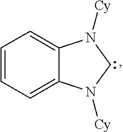

wherein Cy refers to cyclohexyl.

In general, n can be 3 or more. In embodiments, n can be 3 to 1,000,000, 10 to 1,00,000, 10 to 100,000, or 10 to 10,000, or 10 to 1000, 3 to 100, or 3 to 50, or 3 to 10.

As used herein, the term “alkyl” refers to straight chained and branched saturated hydrocarbon groups containing one to thirty carbon atoms, for example, one to twenty two carbon atoms, or one to twenty carbon atoms, or one to ten carbon atoms. The term Cₙ means the alkyl group has “n” carbon atoms. For example, C₄alkyl refers to an alkyl group that has 4 carbon atoms. C₁₋₂₂alkyl and C₁-C₂₂alkyl refer to an alkyl group having a number of carbon atoms encompassing the entire range (i.e., 1 to 22 carbon atoms), as well as all subgroups (e.g., 1-20, 2-15, 1-10, 5-12, 1, 2, 3, 4, 5, 6, 7, 8, 9, 10, 11, 12, 13, 14, 15, 16, 17, 18, 19, 20, 21, and 22 carbon atoms). Nonlimiting examples of alkyl groups include, methyl, ethyl, n-propyl, isopropyl, n-butyl, sec-butyl (2-methylpropyl), t-butyl (1,1-dimethylethyl), 3,3-dimethylpentyl, and 2-ethylhexyl. Unless otherwise indicated, an alkyl group can be an unsubstituted alkyl group or a substituted alkyl group.

As used herein, the term “cycloalkyl” refers to an aliphatic cyclic hydrocarbon group containing four to twenty carbon atoms, for example, four to fifteen carbon atoms, or four to ten carbon atoms (e.g., 4, 5, 6, 7, 8, 10, 12, 14, 15, 16, 17, 18, 19 or 20 carbon atoms). The term Cₙ means the cycloalkyl group has “n” carbon atoms. For example, C₅cycloalkyl refers to a cycloalkyl group that has 5 carbon atoms in the ring. C₅₋₈cycloalkyl and C₅-C₈cycloalkyl refer to cycloalkyl groups having a number of carbon atoms encompassing the entire range (i.e., 5 to 8 carbon atoms), as well as all subgroups (e.g., 5-6, 6-8, 7-8, 5-7, 5, 6, 7, and 8 carbon atoms). Nonlimiting examples of cycloalkyl groups include cyclobutyl, cyclopentyl, cyclohexyl, cycloheptyl, and cyclooctyl. Unless otherwise indicated, a cycloalkyl group can be an unsubstituted cycloalkyl group or a substituted cycloalkyl group. The cycloalkyl groups described herein can be isolated or fused to another cycloalkyl group, a heterocycloalkyl group, an aryl group and/or a heteroaryl group.

As used herein, the term “alkenyl” is defined identically as “alkyl,” except for containing at least one carbon-carbon double bond, and having two to twenty carbon atoms, for example, two to twenty carbon atoms, or two to ten carbon atoms. The term Cₙ means the alkenyl group has “n” carbon atoms. For example, C₄alkenyl refers to an alkenyl group that has 4 carbon atoms. C₂₋₇alkenyl and C₂-C₇alkenyl refer to an alkenyl group having a number of carbon atoms encompassing the entire range (i.e., 2 to 7 carbon atoms), as well as all subgroups (e.g., 2-6, 2-5, 3-6, 2, 3, 4, 5, 6, and 7 carbon atoms). Specifically contemplated alkenyl groups include ethenyl, 1-propenyl, 2-propenyl, and butenyl. Unless otherwise indicated, an alkenyl group can be an unsubstituted alkenyl group or a substituted alkenyl group.

As used herein, the term “alkynyl” is defined identically as “alkyl,” except for containing at least one carbon-carbon triple bond, and having two to twenty carbon atoms, for example, two to twenty carbon atoms, or two to ten carbon atoms. The term Cₙ means the alkynyl group has “n” carbon atoms. For example, C₄alkynyl refers to an alkynyl group that has 4 carbon atoms. C₂₋₇alkynyl and C₂-C₇alkynyl refer to an alkynyl group having a number of carbon atoms encompassing the entire range (i.e., 2 to 7 carbon atoms), as well as all subgroups (e.g., 2-6, 2-5, 3-6, 2, 3, 4, 5, 6, and 7 carbon atoms). Specifically contemplated alkynyl groups include ethynyl, 1-propynyl, 2-propynyl, and butynyl. Unless otherwise indicated, an alkenyl group can be an unsubstituted alkynyl group or a substituted alkynyl group.

As used herein, the term “aryl” refers to monocyclic or polycyclic (e.g., fused bicyclic and fused tricyclic) carbocyclic aromatic ring systems having six to twenty carbon atoms, for example six to fifteen carbon atoms or six to ten carbon atoms. The term Cₙ means the aryl group has “n” carbon atoms. For example, C₆aryl refers to an aryl group that has 6 carbon atoms in the ring. Examples of aryl groups include, but are not limited to, phenyl, naphthyl, tetrahydronaphthyl, phenanthrenyl, biphenylenyl, indanyl, indenyl, anthracenyl, and fluorenyl. Unless otherwise indicated, an aryl group can be an unsubstituted aryl group or a substituted aryl group.

As used herein, the term “alkoxy” or “alkoxyl” refers to a “—O-alkyl” group. As used herein, the term “aryloxy” or “aryloxyl” refers to a “—O-aryl” group. As used herein, the term “heteroaryloxy” or “heteroaryloxyl” refers to a “—O-heteroaryl” group.

As used herein, the term “ether” refers to a “—R—O—R—” group, wherein each R independently is an alkyl, cycloalkyl, or aryl group. As used herein, the term “thioether” refers to a “—R—S—R—” group, wherein each R independently is an alkyl, cycloalkyl, or aryl group.

As used herein, the term “substituted,” when used to modify a chemical functional group, refers to the replacement of at least one hydrogen radical on the functional group with a substituent. Substituents can include, but are not limited to, alkyl, cycloalkyl, alkenyl, cycloalkenyl, alkynyl, heterocycloalkyl, heterocycloalkenyl, ether, polyether, thioether, polythioether, aryl, heteroaryl, hydroxyl, oxy, alkoxy, heteroalkoxy, aryloxy, heteroaryloxy, ester, thioester, carboxy, cyano, nitro, amino, amido, acetamide, and halo (e.g., fluoro, chloro, bromo, or iodo). When a chemical functional group includes more than one substituent, the substituents can be bound to the same carbon atom or to two or more different carbon atoms.

As used herein, the term “heteroalkyl” is defined similarly as alkyl except that the straight chained and branched saturated hydrocarbon group contains, in the alkyl chain, one to five heteroatoms independently selected from oxygen (O), nitrogen (N), and sulfur (S). In particular, the term “heteroalkyl” refers to a saturated hydrocarbon containing one to twenty carbon atoms and one to five heteroatoms. In general, in embodiments wherein the heteroalkyl is provided as a substituent, the heteroalkyl is bound through a carbon atom, e.g., a heteroalkyl is distinct from an alkoxy or amino group.

As used herein, the term “heterocycloalkyl” is defined similarly as cycloalkyl, except the ring contains one to five heteroatoms independently selected from oxygen, nitrogen, and sulfur. In particular, the term “heterocycloalkyl” refers to a ring containing a total of five to twenty atoms, for example three to fifteen atoms, or three to ten atoms, of which 1, 2, 3, 4, or 5 of those atoms are heteroatoms independently selected from the group consisting of oxygen, nitrogen, and sulfur, and the remaining atoms in the ring are carbon atoms. Nonlimiting examples of heterocycloalkyl groups include piperdine, tetrahydrofuran, tetrahydropyran, dihydrofuran, morpholine, and the like. The heterocycloalkyl groups described herein can be isolated or fused to another heterocycloalkyl group, a cycloalkyl group, an aryl group, and/or a heteroaryl group. In some embodiments, the heterocycloalkyl groups described herein comprise one oxygen ring atom (e.g., oxiranyl, oxetanyl, tetrahydrofuranyl, and tetrahydropyranyl).

As used herein, the term “heteroaryl” refers to a cyclic aromatic ring system having five to twenty total ring atoms (e.g., a monocyclic aromatic ring with 5-6 total ring atoms), of which 1, 2, 3, 4, or 5 of those atoms are heteroatoms independently selected from the group consisting of oxygen, nitrogen, and sulfur, and the remaining atoms in the ring are carbon atoms. Unless otherwise indicated, a heteroaryl group can be unsubstituted or substituted with one or more, and in particular one to four, substituents selected from, for example, halo, alkyl, alkenyl, OCF₃, NO₂, CN, NC, OH, alkoxy, amino, CO₂H, CO₂alkyl, aryl, and heteroaryl. In some cases, the heteroaryl group is substituted with one or more of alkyl and alkoxy groups. Heteroaryl groups can be isolated (e.g., pyridyl) or fused to another heteroaryl group (e.g., purinyl), a cycloalkyl group (e.g., tetrahydroquinolinyl), a heterocycloalkyl group (e.g., dihydronaphthyridinyl), and/or an aryl group (e.g., benzothiazolyl and quinolyl). Examples of heteroaryl groups include, but are not limited to, thienyl, furyl, pyridyl, pyrrolyl, oxazolyl, quinolyl, thiophenyl, isoquinolyl, indolyl, triazinyl, triazolyl, isothiazolyl, isoxazolyl, imidazolyl, benzothiazolyl, pyrazinyl, pyrimidinyl, thiazolyl, and thiadiazolyl. When a heteroaryl group is fused to another heteroaryl group, then each ring can contain five to twenty total ring atoms and one to five heteroatoms in its aromatic ring.

As used herein, the term “hydroxy” or “hydroxyl” refers to the “—OH” group. As used herein, the term “thiol” refers to the “—SH” group.

As used herein, the term “alkylthio” refers to a “—S-alkyl” group. As used herein, the term “arylthio” refers to a “—S-aryl” group. As used herein, the term “heteroarylthio” refers to a “—S-heteroaryl” group.

As used herein, the term “halo” is defined as fluoro, chloro, bromo, and iodo. The term “haloalkyl” refers to an alkyl group that is substituted with at least one halogen, and includes perhalogenated alkyl (i.e., all hydrogen atoms substituted with halogen), for example, CH₃CHCl₂, CH₂ICHBr₂CH₃, or CF₃.

Also provided herein are metallopolymers according to the foregoing disclosure having a structure of formula (I):

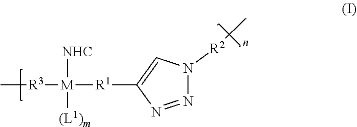

wherein:
NHC is an N-heterocyclic carbene;
R¹ is either a bond or selected from C₁₋₁₀alkyl, C₂₋₆alkynyl, C₀₋₃alkynyl-C₃₋₆cycloalkyl, C₀₋₃alkynyl-Ar¹;
R² is selected from a bond, an electron deficient species, and an electron rich species;
R³ is selected from C₁₋₁₀alkyl, C₂₋₆alkynyl, C₀₋₃alkynyl-C₃₋₆cycloalkyl, C₀₋₃alkynyl-Ar¹, 1,2,3-triazole, C₁₋₁₀alkyl-1,2,3-triazole, C₂₋₆alkynyl-1,2,3-triazole, C₀₋₃alkynyl-C₃₋₆cycloalkyl-1,2,3-triazole, and C₀₋₃alkynyl-Ar¹-1,2,3-triazole;
each L¹ is independently selected from an N-heterocyclic carbene, a phosphine, a phosphite, a phosphonite, a phosphinite, an amine, an amide, an imine, an alkoxy, an aryloxy, an ether, a thioether, an alkylthio, an arylthio, and a five- or six-membered cyclic group having 1 to 3 ring heteroatoms selected from O, N, and S;
n is 10 or more;
m is 1, 2, or 3;
M is a transition metal; and
each Ar¹ is independently selected from C₆ -C₂₂aryl and a 5-12 membered heteroaryl comprising from 1 to 3 ring heteroatoms selected from O, N, and S.

As used herein, the term “cyclic group” refers to any ring structure comprising a cycloalkyl, heterocycloalkyl, aryl, heteroaryl, or a combination thereof. A monocyclic group is a cyclic group comprising just one ring. The cyclic group can be referred to by the number of atoms in the ring back bone, for example, a “5-member cyclic group” refers to a cycloalkyl, heterocycloalkyl, aryl, heteroaryl, or a combination thereof, wherein the cyclic group includes 5 atoms in the ring backbone. Unless otherwise indicated, a cyclic group can be an unsubstituted or a substituted cyclic group.

In general, R¹ can be either a bond or selected from C₁₋₁₀alkyl, C₂₋₆alkynyl, C₀₋₃alkynyl-C₃₋₆cycloalkyl, C₀₋₃alkynyl-Ar¹. In embodiments, R¹ is selected from a bond, C₁₋₅alkyl, C₂₋₄alkynyl, and C₂₋₃alkynyl-Ar¹. In embodiments, R¹ is a bond. In embodiments, R¹ is C₂alkynyl. In embodiments, R¹ is C₂alkynyl-Ar¹. In embodiments, R¹ is C₂alkynyl-Ar¹, wherein Ar¹ is Ph.

In general, R² can be selected from a bond, an electron deficient species, and an electron rich species. In embodiments, R² is a bond. In embodiments, R² is an electron deficient species. In embodiments, R² is an electron rich species.

As used herein, the term “electron rich species” refers to a chemical functional group or entity that can readily donate electrons/electron density to another functional group or entity, such as to an electron deficient species. The electron rich species used herein are not particularly limited and can be any electron rich species suitable for organic electronics, e.g., p-dopable polymers. For example, the electron rich species can include, but are not limited to, functional groups selected from alkyl, cycloalkyl, organic acids, organic acid anhydrides, organic acid esters, alcohols, ethers, amines, amine oxides, amides, thiols, thioethers, various phosphate esters, amides, or the like. In embodiments, the electron rich species includes an alkyl, a thioether, an ether, or an amine. In embodiments, the electron rich species is a heteroaromatic compound, such as thiophene or ethylenendioxythiophene, or the like. In embodiments, the electron rich species is selected from

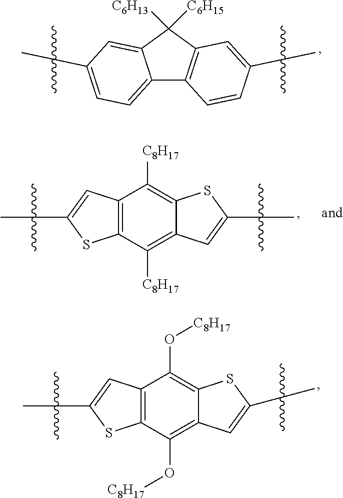

wherein C₈H₁₇ and C₆H₁₃ refer to the linear isomer.

As used herein, the term “electron deficient species” refers to a chemical functional group or entity that accepts electrons/electron density from another functional group or entity, such as from an electron rich species. The electron deficient acceptors used herein are not particularly limited and can be any electron deficient species suitable for organic electronics, e.g., n-dopable polymers. For example, the electron deficient species can include, but are not limited to, functional groups selected from nitrates, nitrites, aryls, heteroaryls, sulfonyl, cyano, haloalkyl, ammonium, or the like. In embodiments, the electron deficient species is a heteroaromatic compound, e.g., pyridyl, benzothiadiazole, or the like. In embodiments, the electron deficient species includes a haloalkyl, a heteroaryl, or a sulfonyl functional group. In embodiments, the electron deficient species is selected from

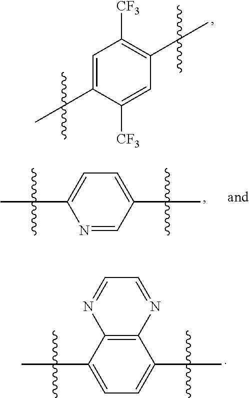

In general, R³ can be selected from C₁₋₁₀alkyl, C₂₋₆alkynyl, C₀₋₃alkynyl-C₃₋₆cycloalkyl, C₀₋₃alkynyl-Ar¹, 1,2,3-triazole, C₁₋₁₀alkyl-1,2,3-triazole, C₂₋₆alkynyl-1,2,3-triazole, C₀₋₃alkynyl-C₃₋₆cycloalkyl-1,2,3-triazole, and C₀₋₃alkynyl-Ar¹-1,2,3-triazole. In embodiments, R³ is C₁₋₅alkyl, C₂₋₄alkynyl, C₂₋₃alkynyl-Ar¹, 1,2,3-triazole, C₂₋₄alkynyl-1,2,3-triazole, or C₀₋₃alkynyl-Ar¹-1,2,3-triazole. In embodiments, R³ is C₂alkynyl. In embodiments, R³ is C₂alkynyl-Ar¹. In embodiments, R³ is C₂alkynyl-1,2,3-triazole. In embodiments, R³ is 1,2,3-triazole. In embodiments, R³ is C₀alkynyl-Ar¹-1,2,3-triazole. In embodiments, R³ is C₂alkynyl-Ar¹-1,2,3-triazole. In embodiments, R³ is C₁₋₄alkyl-1,2,3-triazole.

In general, each L¹ is a ligand (e.g., a neutral ligand or an anionic ligand) and can be independently selected from an N-heterocyclic carbene, a phosphine, a phosphite, a phosphonite, a phosphinite, an amine, an amide, an imine, an alkoxy, an aryloxy, an ether, a thioether, an alkylthio, an arylthio, and a five- or six-membered cyclic group having 1 to 3 ring heteroatoms selected from O, N, and S. The five- or six-membered monocyclic groups can include 1 to 4 heteroatoms, 1 to 3 heteroatom, or 1 to 2 heteroatoms, for example, pyridine, pyridazine, pyrimidine, pyrazine, triazine, pyrrole, pyrazole, imidazoletriazole, pyran, pyrone, dioxin, and furan. The five- or six-membered monocyclic groups can be substituted with halo, C₁-C₂₀alkyl, C₁-C₂₀heteroalkyl, C₅-C₂₄aryl, C₅-C₂₄heteroaryl, and functional groups, including but not limited to, C₁-C₂₀alkoxy, C₅-C₂₄aryloxy, C₂-C₂₀alkylcarbonyl, C₆-C₂₄arylcarbonyl, carboxy, carboxylate, carbamoyl, carbamido, formyl, thioformyl, amino, nitro, and nitroso. Phosphine and amine ligands can include primary, secondary, and tertiary phosphines and amines. The phosphine and amine ligands can include 0 to 3 alkyl groups, 1 to 3 alkyl groups, or 1 to 2 alkyl groups selected from C₁-C₂₀alkyl. The phosphine and amine ligands can also include 0 to 3 aryl or heteroaryl groups, 1 to 3 aryl or heteroaryl groups, or 1 to 2 aryl or heteroaryl groups selected from five- and six-membered aryl or heteroaryl rings. In embodiments, at least one L¹ is an ether, such as, diethyl ether or THF, a phosphine, a NHC, or an amine, such as pyridine or triethyl amine. In embodiments, at least one L¹ is a phosphine. In embodiments, each L¹ is a phosphine. In embodiments, at least one L¹ is a NHC. In embodiments, each L¹ is a NHC. In embodiments, wherein m is 2 or 3, two L¹ together can form a bidentate ligand.

In embodiments, each L¹ is independently selected from C₂-C₂₀amide, C₁-C₂₀alkoxy, C₆-C₂₀aryloxy, C₁-C₂₀heteroaryloxy comprising 1 to 5 heteroatoms selected from O, N, and S, C₁-C₂₀alkylthio, C₆-C₂₀arylthio, C₁-₂₀heteroarylthio comprising 1 to 5 heteroatoms selected from O, N, and S. In embodiments, at least one L¹ is a C₁-₂₀alkoxy. In embodiments, each L¹ is a C₁-C₅alkoxy. In embodiments, at least one L¹ independently is a C₁-C₅alkoxy. In embodiments, each L¹ independently is a C₁-C₅alkoxy.

When referring to a ligand, the term “amine” refers to a NH₃ group, where 0, 1, 2, or 3 hydrogens can be replaced with an alkyl, cycloalkyl, or aryl group. When referring to a ligand, the term “amide” refers to a NR₂ group, wherein each R is independently a hydrogen, alkyl, cycloalkyl, or aryl group. When referring to a ligand, the term “imine” refers to a NR group, wherein R is a hydrogen, alkyl, cycloalkyl, or aryl group

As used herein, the term “phosphine” refers to a —PH₃ group, wherein 0, 1, 2, or 3 hydrogens can be replaced with an alkyl, cycloalkyl, or aryl group. As used herein “phosphite” refers to a P(OR)₃ group, wherein each R can individually be alkyl, cycloalkyl, or aryl. As used herein, “phosphonite” refers to a PR(OR)₂ group, wherein each R can individually be alkyl, cycloalkyl, or aryl. As used herein, “phosphinite” refers to a PR₂(OR) group, wherein each R can individually be alkyl, cycloalkyl, or aryl. As used herein, the term “diphosphine” refers to a P(R₂)—(CH₂)ₙ—P(R₂) group, wherein each R can individually be alkyl, cycloalkyl, or aryl and n can be 1, 2, 3, 4, or 5.

As used herein, “bidentate ligand” refers to a ligand that has two atoms that can coordinate directly to the metal center of a metal complex, e.g., a single molecule which can form two bonds to a metal center. Non-limiting examples of bidentate ligands include ethylenediamine, bipyridine, phenanthroline, and diphosphine.

A “neutral ligand,” as used herein, refers to a ligand that, when provided as a free molecule, does not bear a charge. Examples of neutral ligands include water, phosphines, ethers (e.g., tetrahydrofuran), and amines (e.g., pyridine, triethylamine, or the like). An “anionic ligand” refers to a ligand that, when provided as a free molecule, has a formal charge of −1. Examples of anionic ligands include, amides, chloride, methoxy, ethoxy, ispropoxy, tertbutoxy, tertbutyl, neopentyl, and cyclopentadienyl.

In general, m can be 1, 2, or 3. In embodiments, m is 1. In embodiments, m is 2. In embodiments, m is 3.

In general, each Ar¹ can be independently selected from C₆-C₂₂aryl and a 5-12 membered heteroaryl comprising from 1 to 3 ring heteroatoms selected from O, N, and S. In embodiments, at least one Ar¹ is Ph. In embodiments, at least one Ar¹ is a 5-12 membered heteroaryl comprising from 1 to 3 ring heteroatoms selected from O, N, and S.

Also provided herein are metallopolymers according to the foregoing disclosure having a structure of formula (IIa) or (IIb):

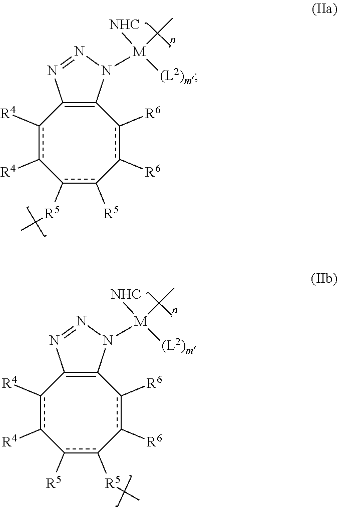

wherein:
each dashed line indicates an optional double bond;
NHC is an N-heterocyclic carbene;
each L² is independently selected from an N-heterocyclic carbene, a phosphine, a phosphite, a phosphonite, a phosphinite, an amine, an amide, an imine, an alkoxy, an aryloxy, an ether, a thioether, an alkylthio, an arylthio, and a five- or six-membered monocyclic group having 1 to 3 ring heteroatoms selected from O, N, or S;
each R⁴ is independently selected from H, C₁₋₁₀alkyl, C₅-C₈cycloalkyl, and Ar², or both R⁴, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S;
each R⁵ is independently selected from H, C₁₋₁₀alkyl, C₅-C₈cycloalkyl, and Ar² or both R⁵, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S;
each R⁶ is independently selected from H, C₁₋₁₀alkyl, C₅-C₈cycloalkyl, and Ar², or both R⁶, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S;
n is 10 or more;
m [symbol] 0 is 1, 2, or 3;
M is a transition metal; and,
each Ar² is independently selected from C₆-C₂₂aryl and a 5-12 membered heteroaryl comprising from 1 to 3 ring heteroatoms selected from O, N, and S.

In general, each L² can be independently selected from an N-heterocyclic carbene, a phosphine, a phosphite, a phosphonite, a phosphinite, an amine, an amide, an imine, an alkoxy, an aryloxy, an ether, a thioether, an alkylthio, an arylthio, and a five- or six-membered monocyclic group having 1 to 3 ring heteroatoms selected from O, N, or S. In embodiments, at least one L² is an ether, such as, diethyl ether or THF, a phosphine, a NHC, or an amine, such as pyridine or triethyl amine. In embodiments, at least one L² is a phosphine. In embodiments, each L² is a phosphine. In embodiments, at least one L² is a NHC. In embodiments, each L² is a NHC. In embodiments, wherein m′ is 2 or 3, two L² together can form a bidentate ligand.

In embodiments, each L² is independently selected from C₂-C₂₀amide, C₁-C₂₀alkoxy, C₆-C₂₀aryloxy, C₁-C₂₀heteroaryloxy comprising 1 to 5 heteroatoms selected from O, N, and S, C₁-₂₀alkylthio, C₆-₂₀arylthio, C₁-C₂₀heteroarylthio comprising 1 to 5 heteroatoms selected from O, N, and S. In embodiments, at least one L² is a C₁-₂₀alkoxy. In embodiments, each L² is a C₁-C₅alkoxy. In embodiments, at least one L² independently is a C₁-C₅alkoxy. In embodiments, each L² independently is a C₁-C₅alkoxy.

In general, m′ can be 1, 2, or 3. In embodiments, m′ is 1. In embodiments, m′ is 2. In embodiments, m′ is 3.

In general, each R⁴ can be independently selected from H, C₁₋₁₀alkyl, C₅-C₈cycloalkyl, and Ar², or both R⁴, taken together with the carbon atoms to which they are attached, form an aryl, heteroaryl, or 5-7 membered cycloalkyl, or 5-7 membered heterocycloalkyl comprising from 1 to 3 ring heteroatoms selected from O, N, and S. In embodiments, at least one R⁴ is H. In embodiments, each R⁴ is H. In embodiments, both R⁴, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S. In embodiments, both R⁴, taken together with the carbon atoms to which they are attached, form an aryl. In embodiments, both R⁴, taken together with the carbon atoms to which they are attached, form a Ph or a substituted Ph.

In general, each R⁵ can be independently selected from H, C₁₋₁₀alkyl, C₅-C₈cycloalkyl, and Ar², or both R⁵, taken together with the carbon atoms to which they are attached, form an aryl, heteroaryl, or 5-7 membered cycloalkyl, or 5-7 membered heterocycloalkyl comprising from 1 to 3 ring heteroatoms selected from O, N, and S. In embodiments, at least one R⁵ is H. In embodiments, at least one R⁵ is C₁₋₅alkyl. In embodiments, both R⁵, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S. In embodiments, both R⁵, taken together with the carbon atoms to which they are attached, form a 1,2,3-triazole.

In general, each R⁶ can be independently selected from H, C₁₋₁₀alkyl, C₅-C₈cycloalkyl, and Ar², or both R⁶, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S. In embodiments, at least one R⁶ is H. In embodiments, each R⁶ is H. In embodiments, both R⁶, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S. In embodiments, both R⁶, taken together with the carbon atoms to which they are attached, form an aryl. In embodiments, both R⁶, taken together with the carbon atoms to which they are attached, form a Ph or a substituted Ph.

In general, each Ar² can be independently selected from C₆-C₂₂aryl and a 5-12 membered heteroaryl comprising from 1 to 3 ring heteroatoms selected from O, N, and S. In embodiments, at least one Ar² is Ph. In embodiments, at least one Ar² is a 5-12 membered heteroaryl comprising from 1 to 3 ring heteroatoms selected from O, N, and S.

Also provided herein is a metallopolymer according to the foregoing disclosure having a structure of formulas (IV), (V), (VI) or (VII):

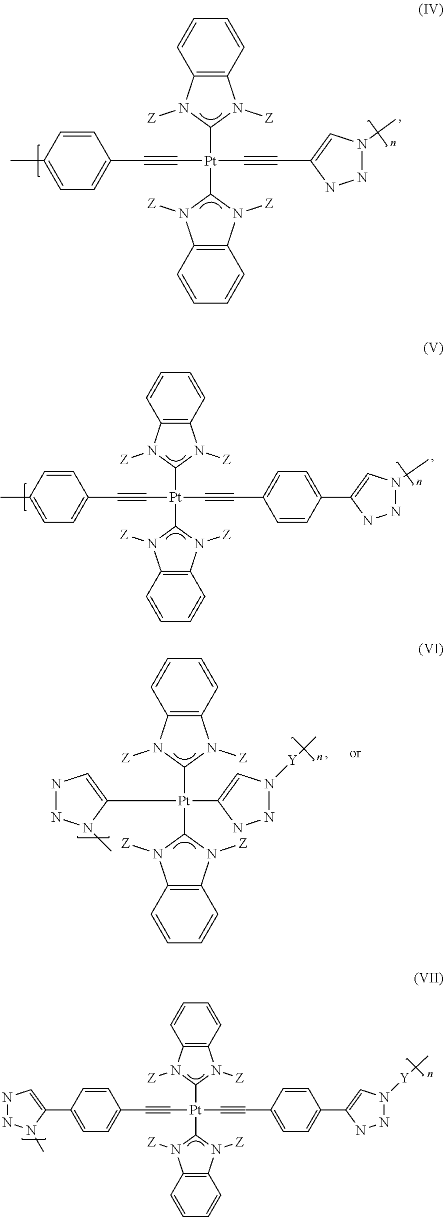

wherein:
each Z is independently selected from C₁₋₂₂alkyl, C₅-C₈cycloalkyl, and Ar⁴;
each Ar⁴ is independently selected from C₆-C₂₂aryl and a 5-12 membered heteroaryl comprising from 1 to 3 ring heteroatoms selected from O, N, and S; and,
Y is an electron rich species or an electron deficient species.

In general, each Z can be independently selected from C₁₋₂₂alkyl, C₅-C₈cycloalkyl, and Ar⁴. In embodiments, at least one Z is Ar⁴. In embodiments, each Z is Ar⁴. In embodiments, at least one Z is Ph. In embodiments, each Z is Ph. In embodiments, at least one Z is cyclohexyl. In embodiments, each Z is cyclohexyl. In embodiments, at least one Z is C₁₋₆alkyl. In embodiments, each Z is C₁₋₆alkyl.

In general, each Ar⁴ can be independently selected from C₆-C₂₂aryl and a 5-12 membered heteroaryl comprising from 1 to 3 ring heteroatoms selected from O, N, and S. In embodiments, at least one Ar⁴ is Ph. In embodiments, at least one Ar⁴ is a 5-12 membered heteroaryl comprising from 1 to 3 ring heteroatoms selected from O, N, and S.

In general, Y can be an electron rich species of the disclosure or an electron deficient species of the disclosure. In embodiments, Y is selected from

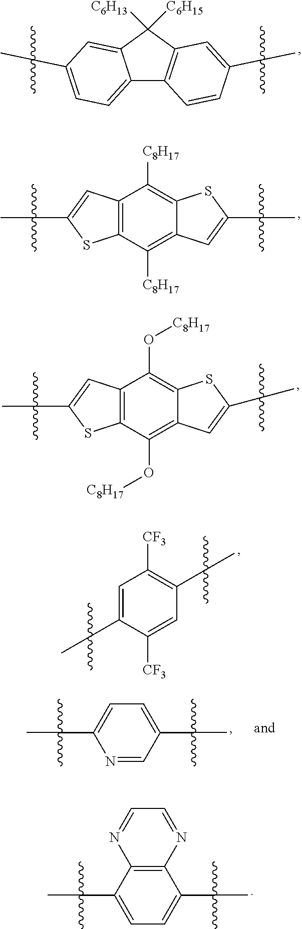

Also provided herein is a metallopolymer having a structure of (IIIa) or (IIIb):

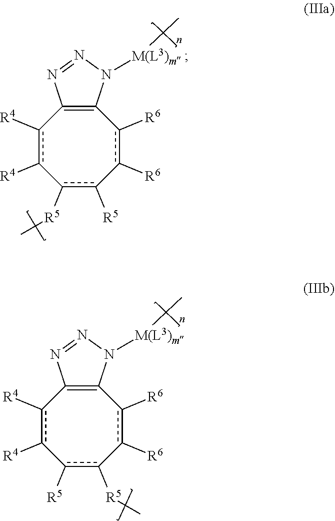

wherein:
the dashed lines indicate optional double bonds;
each L³ is independently selected from a phosphine, a phosphite, a phosphonite, a phosphinite, an amine, an amide, an imine, an alkoxy, an aryloxy, an ether, a thioether, an alkylthio, an arylthio, and a five- or six-membered monocyclic group having 1 to 3 ring heteroatoms selected from O, N, or S;
each R⁷ is independently selected from H, C₁₋₁₀alkyl, C₅-C₈cycloalkyl, and Ar³, or both R⁷, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S;
each R⁸ is independently selected from H, C₁₋₁₀alkyl, C₅-C₈cycloalkyl, and Ar³, or both R⁸, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S;
each R⁹ is independently selected from H, C₁₋₁₀alkyl, C₅-C₈cycloalkyl, and Ar³, or both R⁹, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S;
n is 10 or more;
m″ is 1, 2, 3, or 4;
M is a transition metal; and
each Ar³ is independently selected from C₆-₂₂aryl and a 5-12 membered heteroaryl comprising from 1 to 3 ring heteroatoms selected from O, N, and S.

In general, each L³ can be independently selected from a phosphine, a phosphite, a phosphonite, a phosphinite, an amine, an amide, an imine, an alkoxy, an aryloxy, an ether, a thioether, an alkylthio, an arylthio, and a five- or six-membered monocyclic group having 1 to 3 ring heteroatoms selected from O, N, or S. In embodiments, at least one L³ is an ether, such as, diethyl ether or THF, a phosphine, or an amine, such as pyridine or triethyl amine. In embodiments, at least one L³ is a phosphine. In embodiments, each L³ is a phosphine. In embodiments, at least one L³ is a ether. In embodiments, each L³ is a ether. In embodiments, at least one L³ is a thioether. In embodiments, each L³ is a thioether. In embodiments, wherein m′ is 2 or 3, two L³ together can form a bidentate ligand.

In embodiments, each L³ is independently selected from C₂-C₂₀amide, C₁-C₂₀alkoxy, C₆-₂₀aryloxy, C₁-C₂₀heteroaryloxy comprising 1 to 5 heteroatoms selected from O, N, and S, C₁-C₂₀alkylthio, C₆-₂₀arylthio, C₁-C₂₀heteroarylthio comprising 1 to 5 heteroatoms selected from O, N, and S. In embodiments, at least one L³ is a C₁-C₂₀alkoxy. In embodiments, each L³ is a C₁-C₅alkoxy. In embodiments, at least one L³ independently is a C₁-C₅alkoxy. In embodiments, each L³ independently is a C₁-C₅alkoxy.

In general, m″ can be 1, 2, 3, or 4. In embodiments, m″ is 1. In embodiments, m″ is 2. In embodiments, m″ is 3. In embodiments, m″ is 4.

In general, each R⁷ can be independently selected from H, C₁₋₁₀alkyl, C₅-C₈cycloalkyl, and Ar³, or both R⁷, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S. In embodiments, at least one R⁷ is H. In embodiments, each R⁷ is H. In embodiments, both R⁷, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S. In embodiments, both R⁷, taken together with the carbon atoms to which they are attached, form an aryl. In embodiments, both R⁷, taken together with the carbon atoms to which they are attached, form a Ph or a substituted Ph.

In general, each R⁸ can be independently selected from H, C₁₋₁₀alkyl, C₅-C₈cycloalkyl, and Ar³, or both R⁸, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S. In embodiments, at least one R⁸ is H. In embodiments, at least one R⁸ is C₁₋₅alkyl. In embodiments, both R⁸, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S. In embodiments, both R⁸, taken together with the carbon atoms to which they are attached, form a 1,2,3-triazole.

In general, each R⁹ can be independently selected from H, C₁₋₁₀alkyl, C₅-C₈cycloalkyl, and Ar³, or both R⁹, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S. In embodiments, at least one R⁹ is H. In embodiments, each R⁶ is H. In embodiments, both R⁹, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S. In embodiments, both R⁹, taken together with the carbon atoms to which they are attached, form an aryl. In embodiments, both R⁹, taken together with the carbon atoms to which they are attached, form a Ph or a substituted Ph.

In general, each Ar³ can be independently selected from C₆-C₂₂aryl and a 5-12 membered heteroaryl comprising from 1 to 3 ring heteroatoms selected from O, N, and S. In embodiments, at least one Ar³ is Ph. In embodiments, at least one Ar³ is a 5-12 membered heteroaryl comprising from 1 to 3 ring heteroatoms selected from O, N, and S.

In embodiments, the metallopolymer having a structure of (IIIa) or (IIIb) can have a structure of:

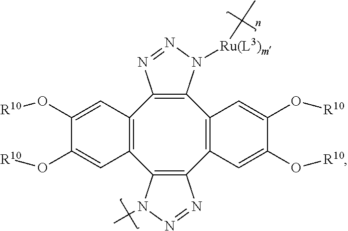

wherein n is 3 or more, m″ is 4, each L³ is a phosphine, and each R¹⁰ is independently selected from C₁₋₂₂alkyl and C₅-C₈cycloalkyl. In embodiments, each R¹⁰ is C₄₋₁₀alkyl. In embodiments, each R¹⁰ is C₆alkyl.

Also provided herein is a metallopolymer having a structure of formula (IX), (X), (XII), or (XIII):

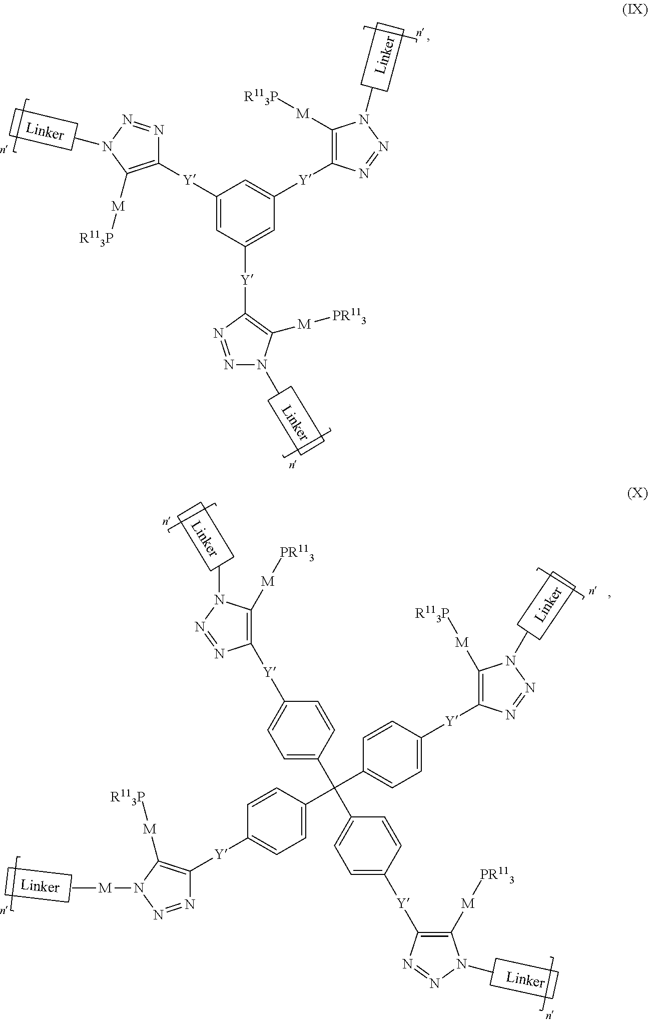

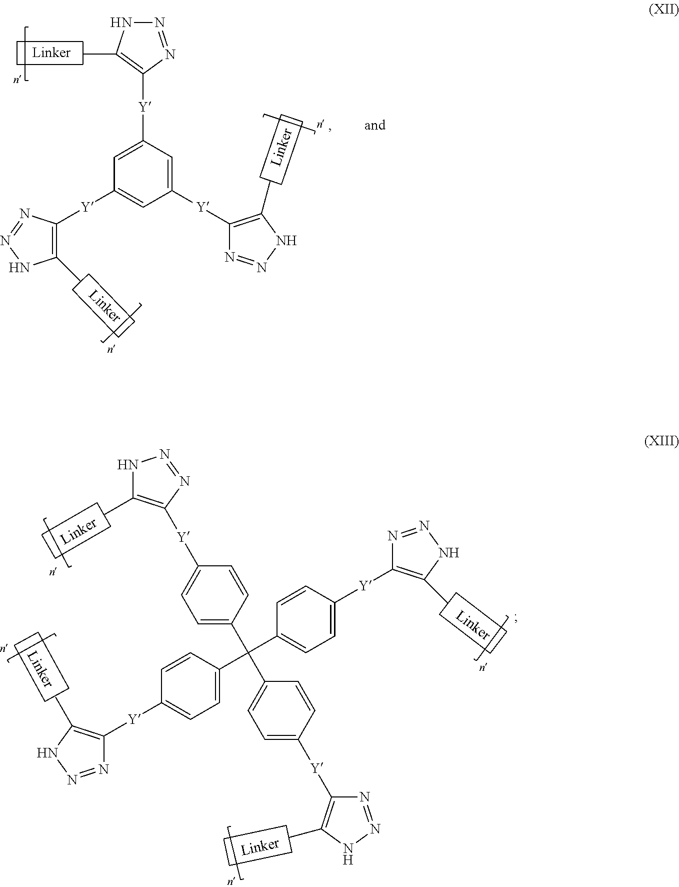

wherein:
each [symbol] has a structure:

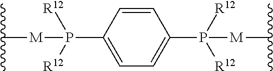

each M is a transition metal;
each R¹¹ is independently selected from H, C₁₋₁₀alkyl, C₅-C₈cycloalkyl, Ar³, heteroaryl, and 5-7 membered heterocycloalkyl comprising from 1 to 3 ring heteroatoms selected from O, N, and S;
each R¹² is independently selected from H, C₁₋₁₀alkyl, C₅-C₈cycloalkyl, Ar³, and 5-7 membered heterocycloalkyl comprising from 1 to 3 ring heteroatoms selected from O, N, and S;
each n′ is an integer;
each Y′ is absent or independently selected from C₁₋₁₀alkyl and Ar³; and
each Ar³ is independently selected from C₆-C₂₂aryl and a 5-12 membered heteroaryl comprising from 1 to 3 ring heteroatoms selected from O, N, and S.

In general, each M can be a transition metal. In embodiments, each M is independently selected from Au, Pt, Pd, and Ag. In embodiments, at least one M is Au. In embodiments, all M are Au. In embodiments, at least one M is Pt. In embodiments, all M are Pt.

In general, each R¹¹ can independently be H, C₁₋₁₀alkyl, C₅-C₈cycloalkyl, Ar³, heteroaryl, or 5-7 membered heterocycloalkyl comprising from 1 to 3 ring heteroatoms selected from O, N, and S. In embodiments, at least one R¹¹ is phenyl. In embodiments, all R¹¹ are phenyl. In embodiments, at least one R¹¹ is ethyl. In embodiments, all R¹¹ are ethyl.

In general, each R¹² can independently be H, C₁₋₁₀alkyl, C₅-C₈cycloalkyl, Ar³, or 5-7 membered heterocycloalkyl comprising from 1 to 3 ring heteroatoms selected from O, N, and S. In embodiments, at least one R¹² is phenyl. In embodiments, all R¹² are phenyl. In some embodiments, all R¹¹ are phenyl and all R¹² are phenyl. In some embodiments, all R¹¹ are phenyl and all R¹² are ethyl. In some embodiments, all R¹¹ are ethyl and R¹² are phenyl. In some embodiments, all R¹¹ are ethyl and all R¹² are ethyl.

In general, each n′ can be an integer. In embodiments, each n′ is at least 2. In embodiments, each n′ is at least 3, at least 4, at least 5, at least 6, at least 7, at least 8, at least 9, or at least 10.

In general, each Y′ can independently be C₁₋₁₀alkyl or Ar³, or each Y′ can independently be absent. In embodiments, all Y′ are absent. In embodiments, at least one Y′ is a C₁₋₁₀alkyl. In embodiments, at least one Y′ is selected from methyl, ethyl, and propyl. In embodiments, each Y′ is selected from methyl, ethyl, and propyl. In embodiments, at least one Y′ is phenyl. In embodiments, all Y′ are phenyl. In embodiments, at least one Y′ is Ar³.

In general, each Ar³, when present, can independently be C₆-C₂₂aryl or a 5-12 membered heteroaryl comprising from 1 to 3 ring heteroatoms selected from O, N, and S. In embodiments, at least one Ar³ is present, and at least one Ar³ C₆-C₂₂aryl. In embodiments, at least one Ar³ is present, and all Ar³ C₆-C₂₂aryl. In embodiments, no Ar³ are present.

In general, the [symbol] is symmetric. In general, the [symbol] interacts with more than one monomer unit in Formula (IX) and (X). In general, the monomer unit has a center structure with branches comprising a triazole-metal complex. In embodiments, the monomer unit can be

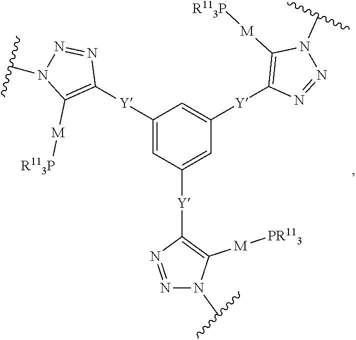

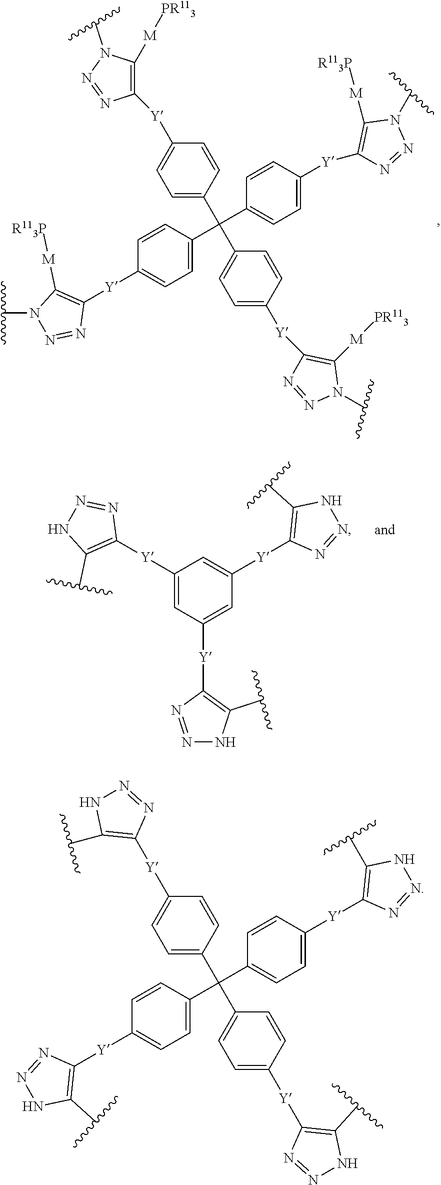

In embodiments, the metallopolymer can be selected from the group of:

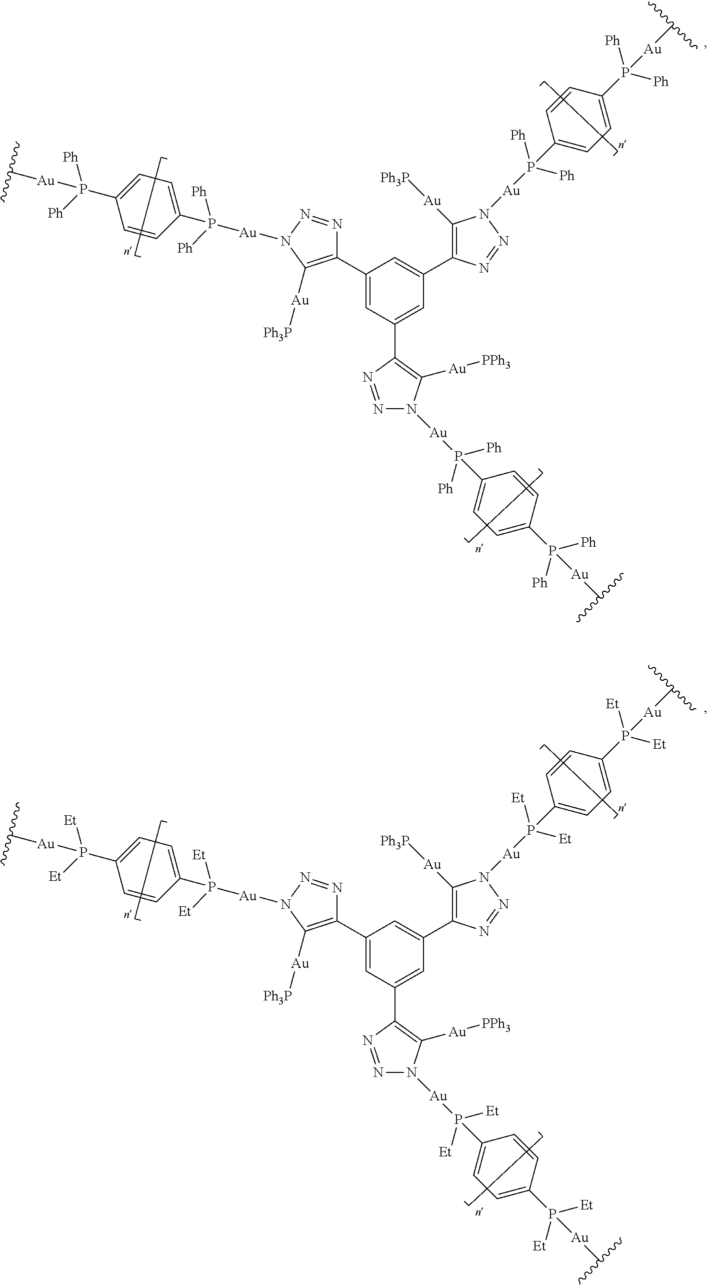

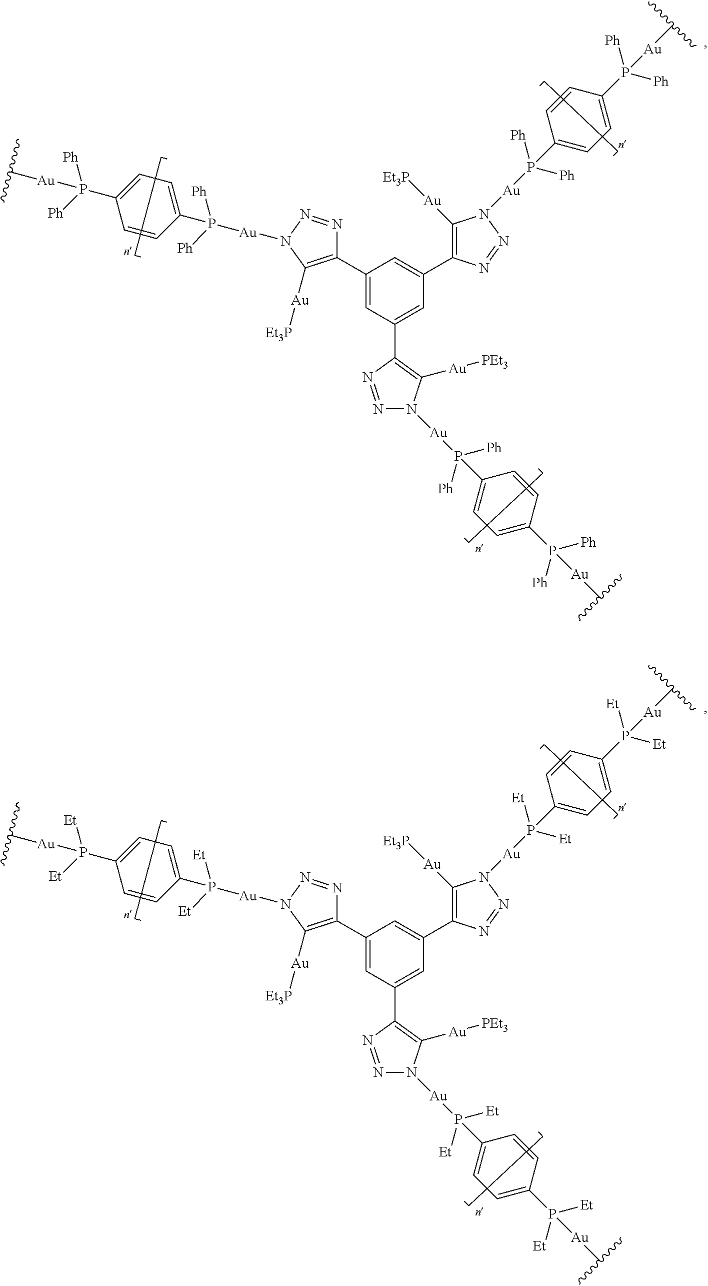

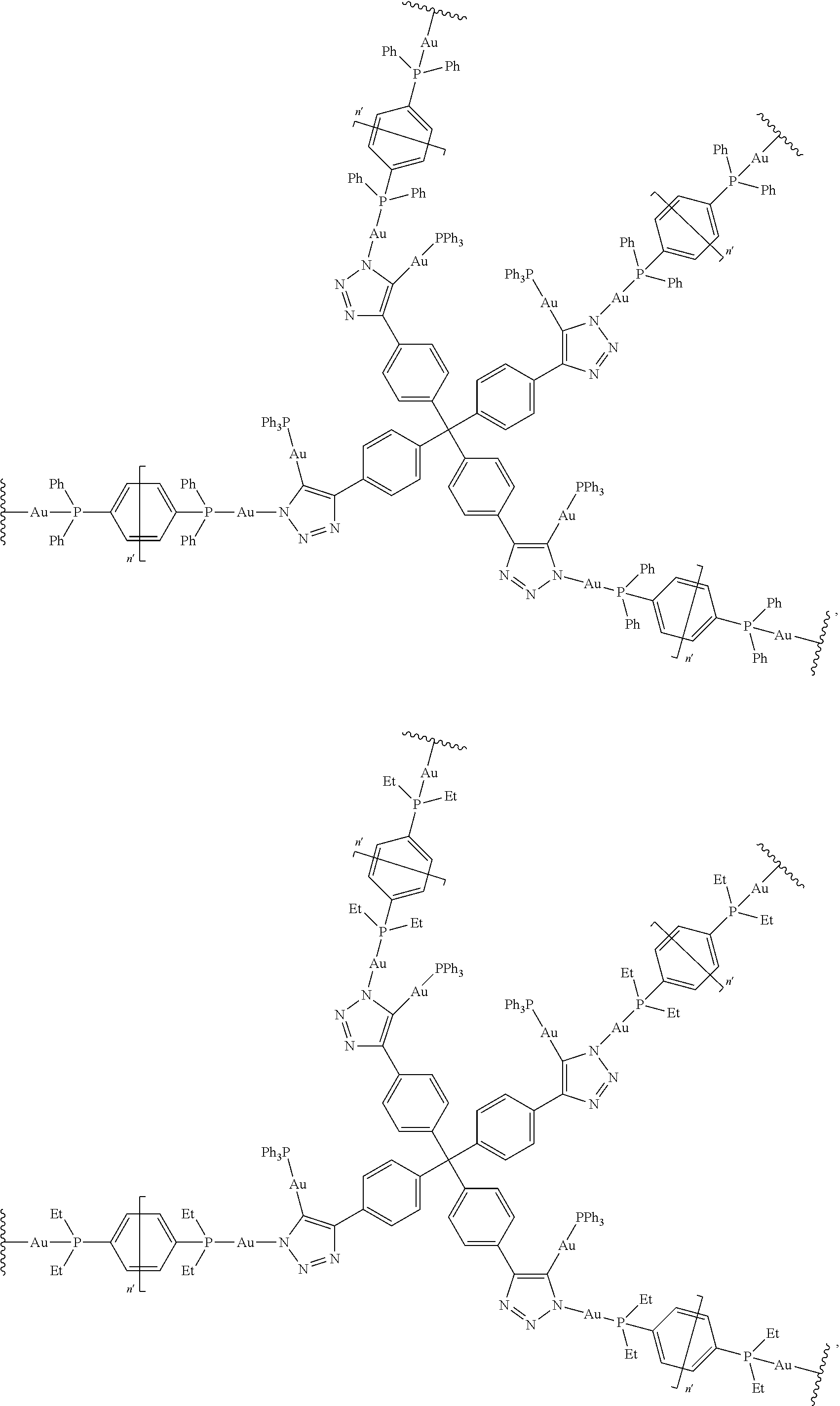

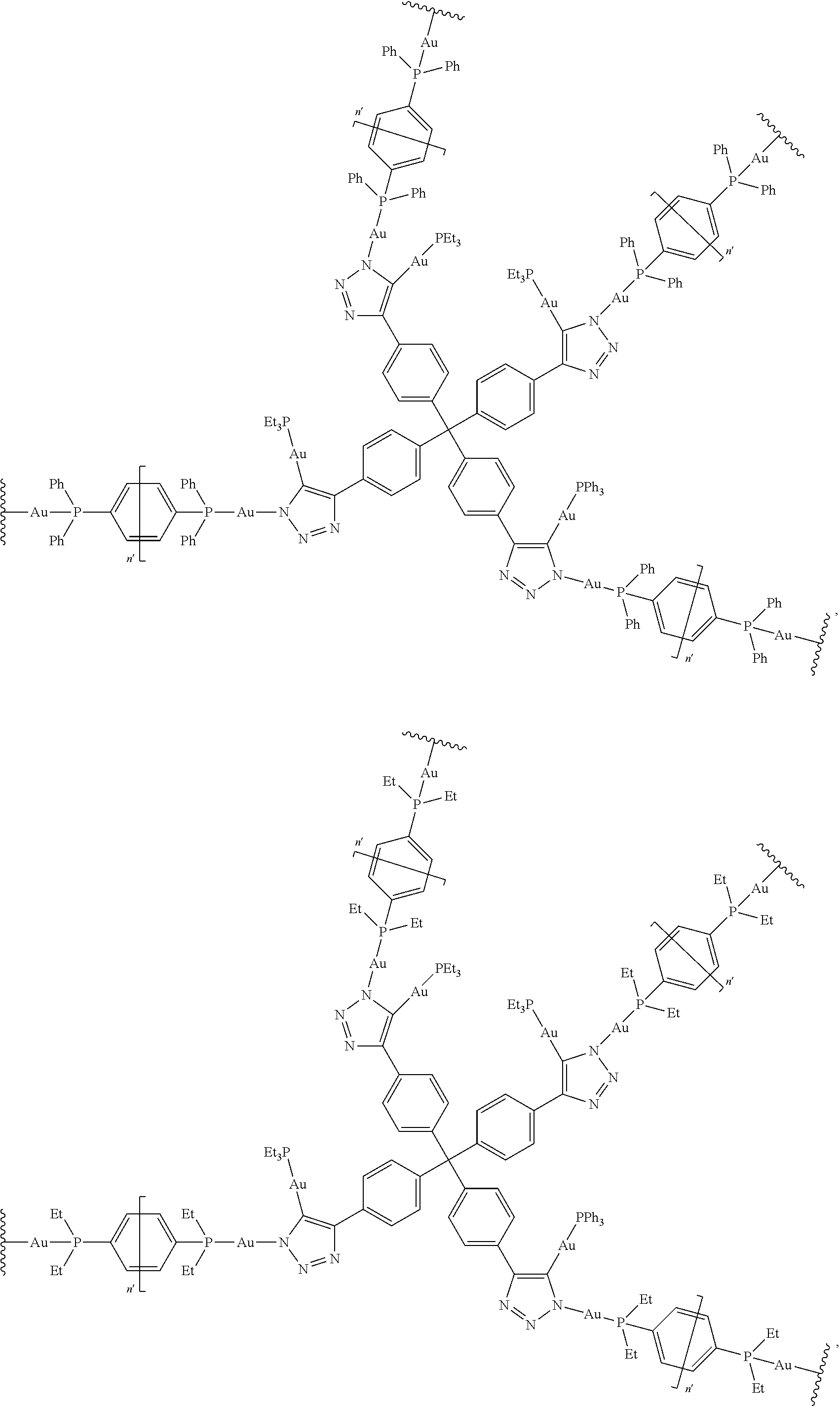

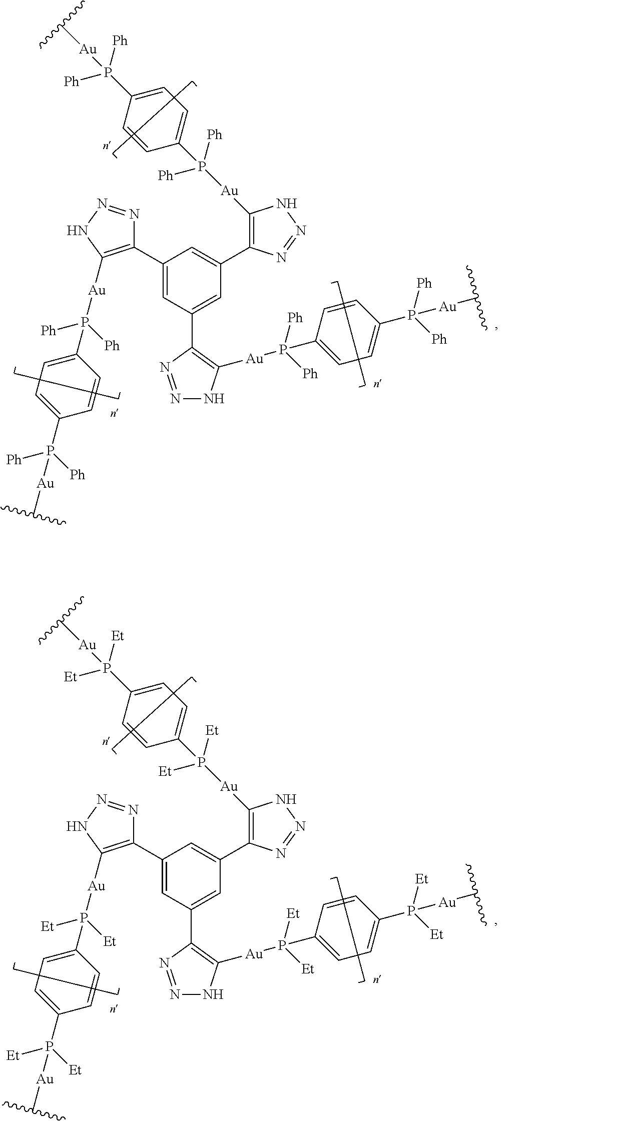

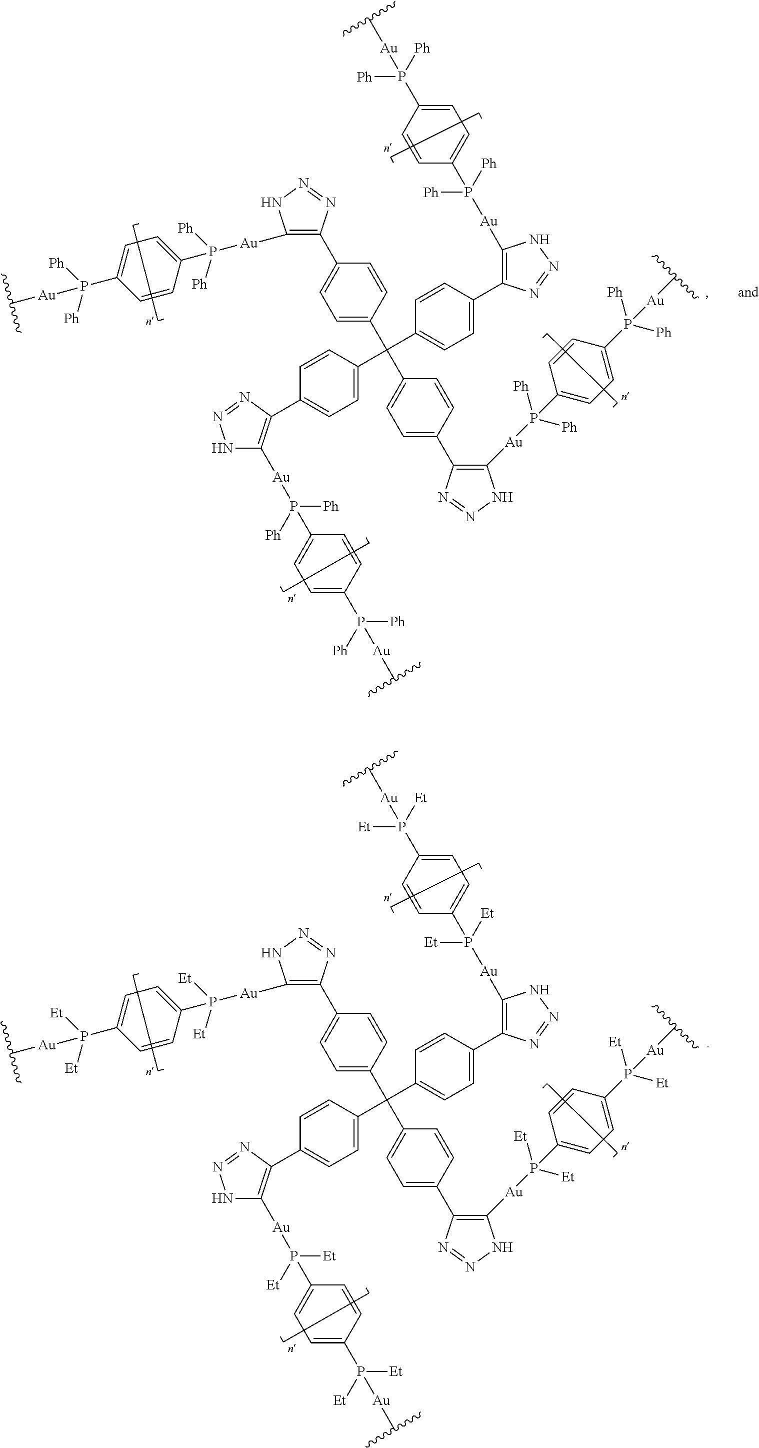

### Methods of Preparing the Metallopolymers of the Disclosure

The disclosure further provides a method of preparing the metallopolymers of the disclosure. The method comprises admixing an azide-containing compound and an alkyne-containing compound under conditions sufficient to form a metallopolymer of the disclosure, wherein, one or both of the azide-containing compound and the alkyne-containing compound further comprises a transition metal. In embodiments, one or both of the azide-containing compound and the alkyne-containing compound further comprises an N-heterocyclic carbene. In embodiments, the method can further comprise admixing a catalyst with the azide-containing compound and the alkyne-containing compound. In embodiments, the admixing is performed in the absence of a catalyst. In embodiments, the catalyst comprises copper. In embodiments, the catalyst is a Cu(II) salt including a reducing agent, such as ascorbate or the like. In embodiments, the catalyst is CuX, wherein X is a halogen such as CI, Br, or I.

For example, Scheme 1 and 2 below show methods of preparing a metallopolymers of the disclosure in the absence of a catalyst.

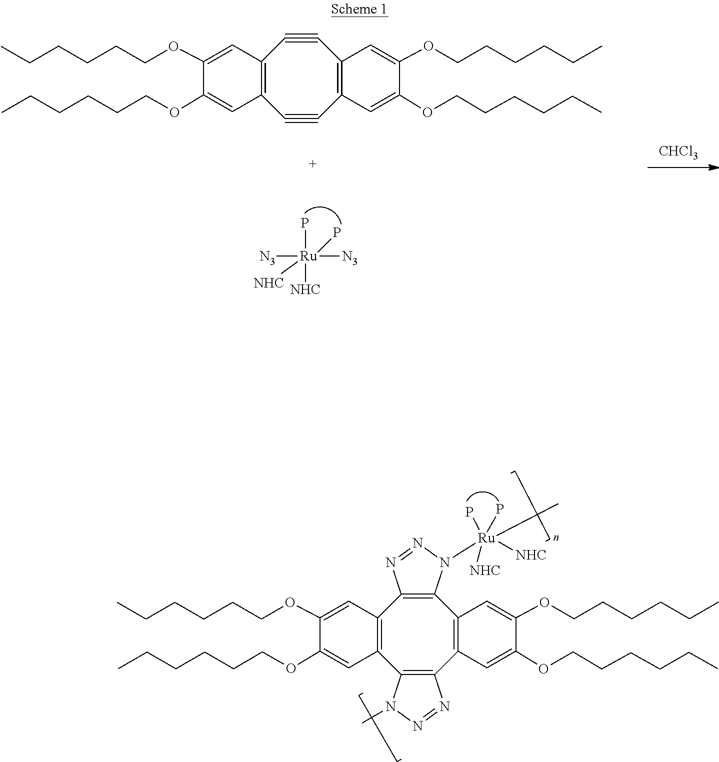

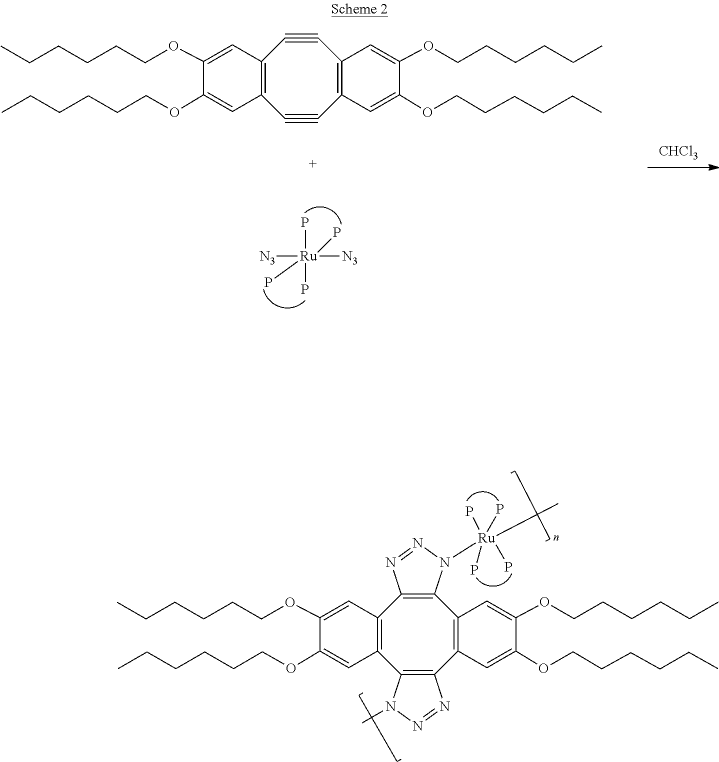

For example, Scheme 3 and 4 below show methods of preparing the metallopolymers of the disclosure with a catalyst (e.g., Cu(I)), wherein R can be an electron rich species or an electron deficient species, such as

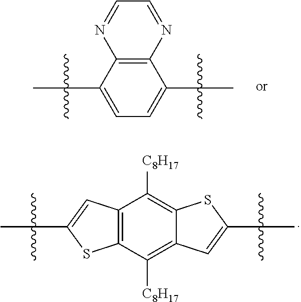

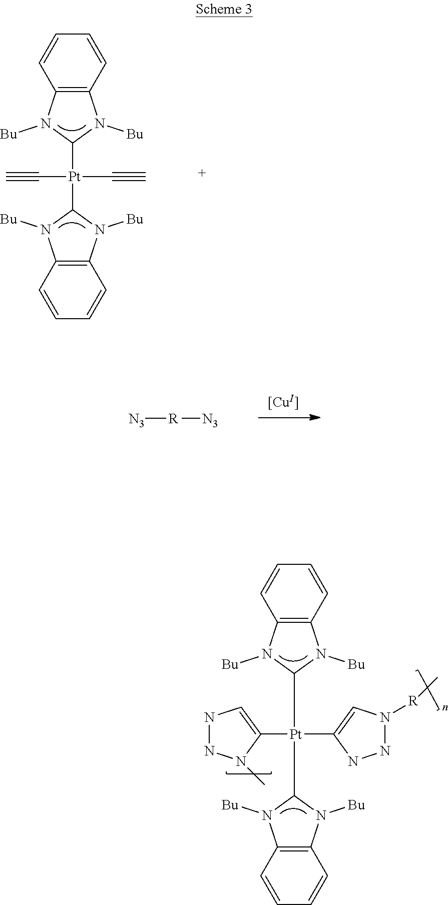

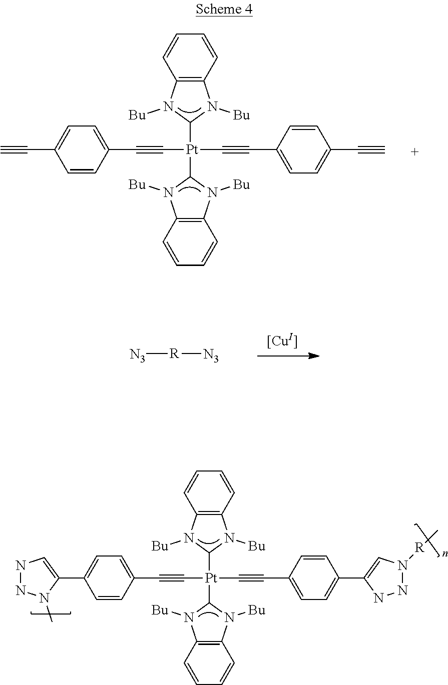

In general, the azide-containing compound can include at least one azide functional group. In embodiments, the azide-containing compound includes two or more azide functional groups. In embodiments, the azide-containing compound includes two azide functional groups.

In general, the alkyne-containing compound can include at least one alkyne functional group. In embodiments, the alkyne-containing compound includes two or more alkyne functional groups. In embodiments, the alkyne-containing compound includes two alkyne functional groups.

In embodiments, the azide-containing compound includes the same number of azide functional groups (e.g., 1 or 2) as the alkyne-containing compound includes alkyne functional groups (e.g., 1 or 2). In embodiments, the azide-containing compound includes 1 azide functional group and the alkyne-containing compound includes 1 alkyne functional group. In embodiments, the azide-containing compound includes 2 azide functional groups and the alkyne-containing compound includes 2 alkyne functional groups.

In embodiments, the azide-containing compound comprises one or more transition metals of the disclosure, such as, 1, 2, 3, or 4 transition metals. In embodiments, the azide-containing compound comprises one transition metal. In embodiments, the azide-containing compound comprises two transition metal.

In embodiments, the alkyne-containing compound comprises one or more transition metals of the disclosure, such as, 1, 2, 3, or 4 transition metals. In embodiments, the alkyne-containing compound comprises one transition metal. In embodiments, the alkyne-containing compound comprises two transition metal.

In general, the azide-containing compound and the alkyne-containing compound can be admixed under conditions sufficient to form the compound having a metallopolymer of the disclosure. In embodiments, the admixing comprises a molar ratio of the azide-containing compound and the alkyne-containing compound of about 1:1, respectively. In embodiments, the admixing comprises a molar ratio of the azide-containing compound and the alkyne-containing compound in a range of about 2:1 to about 1:2, or about 1.5:1 to about 1:1.5, or about 1.3:1 to about 1:1.3, or about 1.1:1 to about 1:1.1, respectively.

In some embodiments, the azide-containing compound and the alkyne-containing compound can be a single compound wherein the compound comprises both an azide functional group and an alkyne functional group. For example, Schemes 5 and 6 show various embodiments of polymerization reactions contemplated herein with compounds including both an azide functional group and an alkyne functional group.

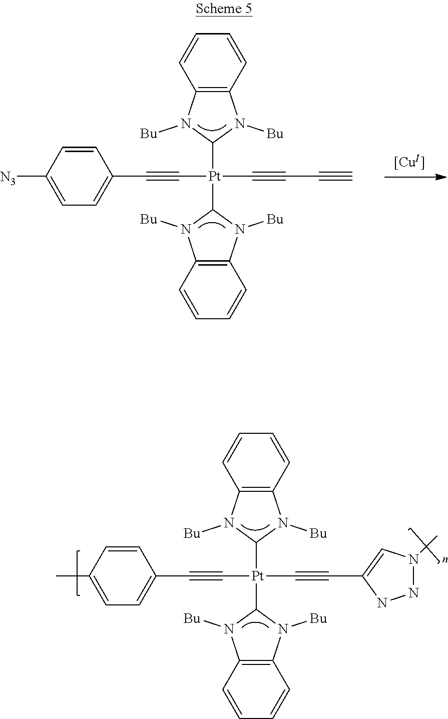

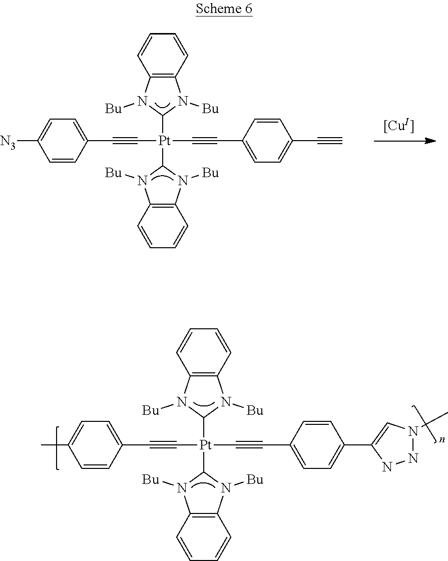

In embodiments wherein the admixing comprises a catalyst, the catalyst is present in an amount of 0.001 mol % to about 20 mol %, based on the mol % of the azide-containing compound. For example, the catalyst is present in an amount of about 1 mol %, about 2 mol %, about 5 mol %, about 10 mol %, or about 20 mol %. In general, when the admixing comprises a catalyst increasing the concentration of the catalyst can increase the rate the reaction to form metallopolymers of the disclosure.

In embodiments, the admixing of the azide-containing compound and the alkyne-containing compound can occur neat, for example, in cases where either or both of the azide-containing compound and the alkyne-containing compound is a liquid. In embodiments, the admixing of the azide-containing compound and the alkyne-containing compound can occur in solution. Suitable solvents include, but are not limited to, nonpolar aprotic solvents, such as, but not limited to, benzene, toluene, hexanes, pentanes, dichloromethane, trichloromethane, chloro-substituted benzenes, deuterated analogs of the foregoing and combinations of the foregoing. As will be understood by one of ordinary skill in the art, polar aprotic solvents may also be suitable provided they do not compete with the iClick reaction or the coordination of ligands at the metal center. Suitable polar aprotic solvents can include, but are not limited to, diethyl ether, ethyl acetate, acetone, dimethylformamide, dimethoxyethane, tetrahydrofuran, acetonitrile, dimethyl sulfoxide, nitromethane, propylene carbonate, deuterated analogs of the foregoing, and combinations of the foregoing.

The admixing of the azide-containing compound and the alkyne-containing compound can occur at any suitable temperature for any suitable time. It is well understood in the art that the rate of a reaction during admixing can be controlled by tuning the temperature. Thus, in general, as the reaction temperature increases the reaction time can decrease.

The polymerization of the metallopolymers of the disclosure can be carried out at, for example, ambient temperatures (e.g., about 20° C. to about 25° C.) at dry conditions (e.g., about 0-1% RH) under an inert atmosphere (e.g., nitrogen or argon). Polymerization temperatures can be in a range of about −80° C. to about 100° C., about −70° C. to about 80° C., about −50° C. to about 75° C., about −25° C. to about 50° C., about 0° C. to about 35° C., about 5° C. to about 30° C., about 10° C. to about 30° C., about 15° C. to about 25° C., about 20° C. to about 30° C., or about 20° C. to about 25° C., for example, about 0° C., about 5° C., about 10° C., about 15° C., about 20° C., about 25° C., about 30° C., or about 35° C. Reaction times can be instantaneous or otherwise until completion. The progress of the reaction can be monitored by standard techniques, e.g., nuclear magnetic resonance (NMR) spectroscopy. In embodiments, the reaction times are in a range of about 30 seconds to about 72 hours, about 1 minute to about 72 hours, about 5 minutes to about 72 hours, about 10 minutes to about 48 hours, about 15 minutes to about 24 hours, about 1 minute to about 24 hours, about 5 minutes to about 12 hours, about 10 minutes to about 6 hours, about 20 minutes to about 1 hour, about 30 minutes (min) to about 12 hours (h), about 1 hour to about 10 hours, about 1 hour to 3 hours, about 25 min to about 6 h, or about 30 min to about 3 h, for example, about 30 seconds, 1 min, 5 min, 10 min, 15 min, 20 min, 25 min, 30 min, 35 min, 40 min, 45 min, 50 min, 55 min, 60 min, 75 min, 90 min, 105 min, 2 h, 3 h, 4 h, 5 h, 6 h, 12 h, 18 h, 24 h, 36 h, 48 h, 60 h, or 72 h. Polymerization times will vary, depending on the particular monomer and the metal complex. It is well understood in the art that when the polymerization time is increased and/or the temperature is increased, the products are likely high molecular weight products, and when the polymerization time is decreased and/or the temperature is decreased, the products are likely low molecular weight products.

Polymerization may be terminated at any time by addition of a solvent effective to precipitate the polymer, for example, methanol. The precipitated polymer may then be isolated by filtration or other conventional means.

The molecular weight of the metallopolymers can be small, equivalent to oligomers of three to ten repeating units (e.g., wherein n is 3 to 10, for example, 3, 4, 5, 6, 7, 8, 9, or 10), or the molecular weights can be of any size up to tens and hundreds of thousands or millions in molecular weight, for example, in a range of about 200 Da to about 5,000,000 Da, about 500 Da to about 4,000,000 Da, about 1,000 Da to about 3,000,000 Da, about 5,000 Da to about 2,000,000 Da or about 10,000 to about 1,000,000 Da (e.g., where n is greater than 3). As used herein, the molecular weights are provided in number average molecular weights determined by gel permeation chromatography relative to polystyrene standards.

Also provided herein are methods of preparing a metallopolymer comprising: admixing a compound of formula (IXa), (Xa), (XIIa), or (XIIIa) with a compound of formula (XI):

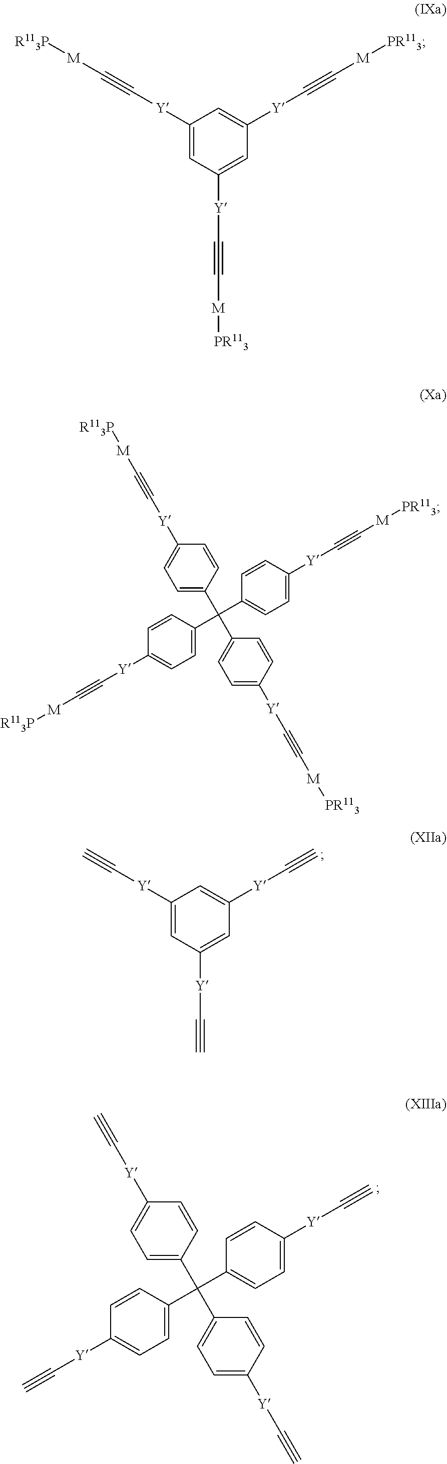

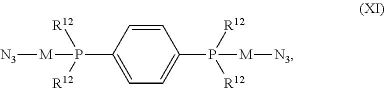

wherein each M is a transition metal; each R¹¹ is independently selected from H, C₁₋₁₀alkyl, C₅-C₈cycloalkyl, Ar³, heteroaryl, and 5-7 membered heterocycloalkyl comprising from 1 to 3 ring heteroatoms selected from O, N, and S; each R¹² is independently selected from H, C₁₋₁₀alkyl, C₅-C₈cycloalkyl, Ar³, and 5-7 membered heterocycloalkyl comprising from 1 to 3 ring heteroatoms selected from O, N, and S; each Y′ is absent or independently selected from C₁₋₁₀alkyl and Ar³; and each Ar³ is independently selected from C₆-C₂₂aryl and a 5-12 membered heteroaryl comprising from 1 to 3 ring heteroatoms selected from O, N, and S.

In general, the compound of formula (IXa) and the compound of formula (XI) can be admixed under conditions sufficient to form the metallopolymer having a structure of formula (IX). In general, the compound of formula (XI) is provided in an amount in a molar excess relative to the amount of the compound of formula (IXa). In embodiments, the compound of formula (IXa) and the compound of formula (XI) are admixed in a molar ratio of 2:3, respectively.

In general, the compound of formula (Xa) and the compound of formula (XI) can be admixed under conditions sufficient to form the metallopolymer having a structure of formula (X). In general, the compound of formula (XI) is provided in an amount in a molar excess relative to the amount of the compound of formula (Xa). In embodiments, the compound of formula (Xa) and the compound of formula (XI) are admixed in a molar ratio of 1:2, respectively.

In general, the compound of formula (XIIa) and the compound of formula (XI) can be admixed under conditions sufficient to form the metallopolymer having a structure of formula (XII). In general, the compound of formula (XI) is provided in an amount in a molar excess relative to the amount of the compound of formula (XIIa). In embodiments, the compound of formula (XIIa) and the compound of formula (XI) are admixed in a molar ratio of 2:3, respectively.

In general, the compound of formula (XIIIa) and the compound of formula (XI) can be admixed under conditions sufficient to form the metallopolymer having a structure of formula (XIII). In general, the compound of formula (XI) is provided in an amount in a molar excess relative to the amount of the compound of formula (XIIIa). In embodiments, the compound of formula (XIIIa) and the compound of formula (XI) are admixed in a molar ratio of 1:2, respectively.

In general, the admixing can occur neat, i.e. without solvent, or with solvent. In embodiments, the compounds are admixed in a solvent. In general, when the admixing occurs in a solvent, the method can further include filtering and washing with additional solvent after the admixing occurs. The reaction solvent and the wash solvent can be the same type of solvent. In general, the solvent can be any solvent sufficient to dissolve at least a portion of, and not react with, the compound of formula (IXa), formula (Xa), formula (XIa), and formula (XIIa), and the compound of formula (XI). In embodiments, the solvent is a halogenated aprotic solvent. In embodiments, the solvent is dichloromethane, dichloroethane, 2-methyltetrahydrofuran or tetrahydrofuran.

In general, the admixing can occur for a time and at a temperature sufficient to form the metallopolymer. In embodiments, the admixing occurs for a time of 1 hour to 7 days at a temperature in a range of 0° C. to 100° C. In embodiments, the admixing occurs for a time of 5 days to 7 days at a temperature in a range of 25° C. to 75° C. In embodiments, the admixing occurs at a temperature in a range of 0° C. to 100° C., for example, 5° C. to 95° C., 10° C. to 90° C., 15° C. to 85° C., 20° C. to 80° C., or 25° C. to 75° C. In embodiments, the admixing occurs for a time in a range of about 1 hour to about 7 days, about 2 hours to about 7 days, about 5 hours to about 7 days, about 6 hours to about 7 days, about 12 hours to about 7 days, about 24 hours to about 7 days, about 36 hours to about 7 days, about 48 hours to about 7 days, about 60 hours to about 7 days, about 72 hours to about 7 days, about 84 hours to about 7 days, about 4 days to about 7 days, or about 5 days to about 7 days.

### EXAMPLES

### Materials and Methods

All manipulations were set up under an inert atmosphere using standard Schlenk or glove-box techniques for convenience; however, the compounds are isolated using benchtop technique and are stable in air. Pentane, dichloromethane (CH₂Cl₂), and tetrahydrofuran (THF) were degassed by sparging with high purity argon and were dried using a GlassContour drying column. Methanol was dried over anhydrous copper(II) sulfate, distilled and stored over 4 Å molecular sieves; chloroform-d (Cambridge Isotopes) was dried over calcium hydride, distilled, and stored over 4 Å molecular sieves.

NMR spectra were recorded on Bruker Ascend HD III 400 and 600 MHz spectrometers. The spectra were recorded at 25° C. unless noted otherwise. Chemical shifts are reported in δ (ppm). ³¹P{¹H} spectra were referenced to an 85% phosphoric acid external standard (0 ppm).

Electrospray ionization mass spectrometry (ESI-MS) spectra were collected by direct injection into an Agilent 6230 Time-of-Flight (TOF) spectrometer at a gas temperature of 350° C. Matrix assisted laser desorption ionization (MALDI) was collected by injection into a Bruker autoflex MALDI TOF using reflectron (900-4500 Da) positive mode. Samples were prepared in DCM at 5 mg/mL, dithranol was used as matrix and was dissolved in DCM at 5 mg/mL. Solutions for analysis were prepared by mixing the sample and matrix at a volume ration of 1:1. The sample was left to air dry after spotting on a stainless steel MALDI target plate. The resulting spectra were analyzed using the MassLynx 4.0 software package.

Infrared spectra were collected on a Thermo Nicolet 5700 Fourier-transform infrared (FTIR) spectrometer equipped with a single bounce, diamond-stage attenuated total reflectance (ATR) accessory. Elemental analyses were performed at the CENTC Elemental Analysis Facility, Department of Chemistry, University of Rochester and their compositions were determined with a PerkinElmer 2400 Series II Analyzer. Thermogravimetric analyses (TGA) were measured under nitrogen with a TGA Q5000 (TA Instruments). About 10-15 mg of each sample was dried under dynamic vacuum for 24 h, then 5 mg portions of these samples were heated at 20° C./min from 25 to 600° C. Differential scanning calorimetry (DSC) thermograms were obtained with a DSC Q1000 (TA instruments). Typically, 4-6 mg of a sample was added to a sealed pan to heat at 5° C./min. The temperature ranged from −70 to 220° C.

All nitrogen and CO₂ adsorption and desorption isotherms were measured using a Quantachrome ASiQsorb iQ3 and ASiQwin system. Between 50-125 mg of samples were employed in each measurement and the samples were outgassed at 110° C. for 12 h under high vacuum. A test for the rate of rise pressure when vacuum valves are closed was employed at the end of outgas process, the samples would remain outgas until the pressure rate change reached below 20 mtorr/min. Nitrogen adsorption and desorption measurements were done at 77 K. Specific surface areas were calculated from adsorption data using Brunauer-Emmett-Teller (BET) methods in the range of 0.01<P/P₀<0.05. CO₂ adsorption and desorption measurements were analyzed at 273 K and 298 K.

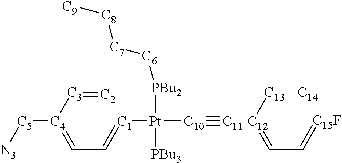

TRANS-4-(AZIDOMETHYL)PHENYL-BIS-TRI-N-BUTYLPHOSPHINE(4-FLUOROPHENYLACETYLIDE)PLATINUM(II) (4-F). Complex 3 (0.194 g, 0.025 mmol) and 1-fluoro-4-ethynylbenzene (0.041 g, 0.034 mmol) were dissolved in HNEt₂ (15 ml). The solution was heated to 60° C. for 7 h. The solvent was then removed in vacuo. The products were washed with hexanes to remove salts and the solvent was removed in vacuo. Fractional column chromatography on silica gel with hexanes/DCM (1:1) as the eluent was employed to purify 4-F as a colorless oil. Yield: 0.172 g, 79.8%. 1H NMR (500 MHz, CDCl₃, 25° C., δ (ppm)): 7.33 (d, ³J_{HH}=7.7 Hz, 2H, HC₂), 7.20 (dd, ³J_{HH}=5.5 Hz, ⁴J_{HH}=−2.75 Hz 2H, HC₁₃), 6.91 (d, ³J_{HH}=7.7 Hz, 2H, HC₃), 6.87 (t, ³J_{HH}=8.8 Hz, 2H, HC₁₄), 4.15 (s, 2H, HC₅), 1.70 (m, 12H, HC₆), 1.48 (m, 12H, HC₇), 1.34 (sex, ³J_{HH}=7.1 Hz, 12H, HC₈), 0.88 (t, ³J_{HH}=7.7 Hz, 18H, HC₉). ¹³C{¹H} NMR (500 MHz, CDCl₃, 25° C., δ (ppm)): 161.3 (C₁₅), 157.6 (C₁), 139.1 (C₂), 131.9 (C₁₃), 127.5 (C₄), 127.4 (C₃), 125.5 (C₁₂), 114.7 (C₁₄), 108.6 (C₁₁), 55.3 (C₅), 26.0 (C₇), 24.3 (C₈), 22.8 (C₆), 13.8 (C₉), ³¹P{¹H} NMR (121.4 MHz, CDCl₃, 25° C., δ (ppm)): 2.0 (s, ¹J_{PtP}=1301 Hz). ¹⁹F NMR (282 MHz, CDCl₃, 25° C., δ (ppm)): −117.2 (m). FTIR (NaCl, cm⁻¹): 3043 (w), 2960 (s), 2929 (s), 2873 (s), 2100 (s), 1587 (w), 1500 (s), 1462 (m), 1415 (m), 1381 (m), 1344 (w), 1232 (m), 1205 (s), 1151 (w), 1091 (w), 906 (m), 831 (s), 791 (m), 737 (m), 526 (m). Anal. Calcd. (%) for C₃₉H₆₄FN₃P₂Pt: C, 55.05; H, 7.58; N, 4.94. Found: C, 55.18; H, 7.30; N, 4.67. HRMS (ESI): m/z calcd. for C₃₉H₆₄FN₃P₂PtNa, [M+Na]⁺: 873.4103; found: 873.4091.

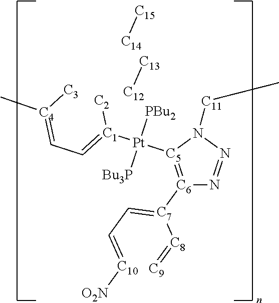

POLY[TRANS-4-(AZIDOMETHYL)PHENYL-BIS-TRI-N-BUTYLPHOSPHINE(4-NITROPHENYLACETYLIDE)PLATINUM(II)] (5-NO₂). Monomer 4-NO₂ (0.060 g, 0.0680 mmol) and CuOAc (0.003 g, 32 mol %) where dissolved in CDCl₃ at room temperature. After 24 h the solution was filtered through Celite® and all volatiles were removed in vacuo to give 5-NO₂ as a red solid. Yield: 46.0 mg, 77%. 1H NMR (500 MHz, CDCl₃, 25° C., δ (ppm)): 8.96 (d, ³J_{HH}=8.5 Hz, 2H, HC₈), 8.27 (d, ³J_{HH}=8.5 Hz, 2H, HC₇), 7.04-7.67 (m, 4H, HC_{2,3}), 5.78 (s, 2H, HC₁₀), 5.61 (s, 2H, HC₁₀), 5.54 (s, 2H, HC₁₀), 4.26 (s, 2H, HC₁₀), 1.23 (m, 36H, HC₁₁₋₁₃), 0.82 (t, ³J_{HH}=6.9 Hz, 18H, HC₁₄). ³¹P{¹H} NMR (121.4 MHz, CDCl₃, 25° C., δ (ppm)): 9.2 (s), 4.9 (s), 0.4 (s, ¹J_{PtP}=1303 Hz), −0.1 (s), −0.2 (s), −0.6 (s). FTIR (NaCl, cm⁻¹): 2958 (w), 2923 (w), 2870 (w), 1595 (w), 1512 (w), 152 (w), 1383 (w), 1329 (w), 1107 (w), 1091 (w), 903 (w), 852 (w). MS (MALDI-TOF): (m/z), 1761.166, 26632.005, 3510.859, 4389.129, 5266.945, 6144.693, DP=9.

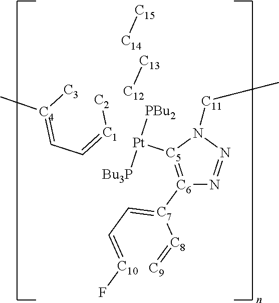

POLY[TRANS-4-(AZIDOMETHYL)PHENYL-BIS-TRI-N-BUTYLPHOSPHINE(4-FLUOROPHENYLACETYLIDE)PLATINUM(II)] (5-F). Monomer 4-F (0.056 g, 0.0630 mmol) and CuOAc (0.0014 g, 20 mol %) where dissolved in CDCl₃ at room temperature. After 24 h the solution was filtered through Celite® and all volatiles were removed in vacuo to give 5-F as a colorless solid. Yield: 44.1 mg, 82%. 1H NMR (500 MHz, CDCl₃, 25° C., δ (ppm)): 8.65 (s, 2H, HC₈), 7.50 (s, 2H, HC₇), 6.88-7.80 (m, 6H, HC_{2,3,7}), 5.74 (s, 2H, HC₁₀), 1.10-1.60 (m, 36H, HC₁₁₋₁₃), 0.82 (t, ³J_{HH}=7.1 Hz, 18H, HC₁₄). ³¹P{¹H} NMR (121.4 MHz, CDCl₃, 25° C., δ (ppm)): 2.1 (s), −2.2 (s, ¹J_{PtP}=1316 Hz), −2.6 (s), −3.3 (s). ¹⁹F NMR (282 MHz, CDCl₃, 25° C., δ (ppm)): −114.3 (m), −118.4 (m). FTIR (NaCl, cm⁻¹): 2955 (s), 2925 (s), 2862 (s), 2042 (w), 2016 (w), 1591 (m), 1479 (m), 1461 (s), 1412 (m), 1375 (m), 1196 (m), 1092 (m), 902 (s), 749 (s), 719 (s), 689 (s). MS (MALDI-TOF): (m/z), 25452, 3397, 4249.421, 5101.725, 5952.860, 6803.979, 7654.636, 8506.143, 9356.611, DP=11.

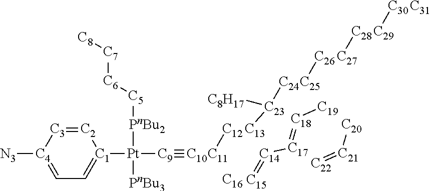

TRANS-4-AZIDOPHENYL-BIS-TRI-N-BUTYLPHOSPHINE(2-ETHYNYL-9,9-DIOCTYL-9H-FLUORENE)PLATINUM(II) (1). Compound 3 (0.216 g, 0.256 mmol) and 2-ethynyl-9,9-dioctyl-9H-fluorene (0.111 g, 0.269 mmol) were taken into DIPA (10 mL) and heated at 60° C. for 20 h. The solvent was removed in vacuo and the resulting mixture of compounds was triturated with hexanes and purified on a silica column with hexanes/DCM (1:1) as the eluent to yield the product (0.225 g, 77.8%). ¹H NMR (500 MHz, CDCl₃, 25° C., δ (ppm)): 7.61 (d, ³J_{HH}=7.3 Hz, 1H, HC₂₂), 7.52 (d, ³J_{HH}=7.8 Hz, 1H, HC₁₅), 7.32 (d, ³J_{HH}=8.3 Hz, 2H, HC₂), 7.30 (m, 1H, HC₁₉), 7.28 (s, 1H, HC₁₂), 7.27 (m, 1H, HC₂₁), 7.25 (m, 1H, HC₁₆), 7.24 (m, 1H, HC₂₀), 6.73 (d, ³J_{HH}=8.3 Hz, 2H, HC₃), 1.90 (dquin, ³J_{HH}=13.2, 4.9 Hz 4H, HC₂₄), 1.77 (m, 12H, HC₅), 1.53 (m, 12H, HC₆), 1.39 (sex, ³J_{HH}=7.3 Hz, 12H, HC₇), 1.21 (sept, ³J_{HH}=7.3 Hz, 4H, HC₂₆), 1.13 (m, 4H, HC₂₇), 1.10 (m, 4H, HC₂₈), 1.04 (m, 4H, HC₂₉), 1.04 (m, 4H, HC₃₀), 0.91 (t, ³J_{HH}=7.3 Hz, 18H, HC₈), 0.82 (t, ³J_{HH}=7.3 Hz, 6H, HC₃₁), 0.62 (dm, ³J_{HH}=36.1 Hz, 4H, HC₂₄). ¹³C{¹H} NMR (500 MHz, CDCl₃, 25° C., δ (ppm)): 153.5 (C₁), 150.7 (C₁₈), 150.2 (C₁₃), 139.8 (C₁₄), 139.7 (C₂), 137.9 (C₁₇), 133.0 (C₄), 129.5 (C₁₆), 127.8 (C₁₁), 126.5 (C₁₂), 126.3 (C₂₀), 125.3 (C₂₁), 122.7 (C₁₉), 119.3 (C₂₂), 119.0 (C₁₅), 117.8 (C₃), 111.4 (C₁₀), 54.7 (C₂₃), 40.5 (C₂₄), 31.8 (C₂₇), 30.2 (C₂₉), 29.3 (C₃₀), 29.3 (C₂₈), 26.2 (C₆), 24.4 (C₇), 23.8 (C₂₅), 22.8 (C₅), 22.6 (C₂₆), 14.0 (C₃₁), 13.8 (C₈). ³¹P{¹H} NMR (121.4 MHz, CDCl₃, 25° C., δ (ppm)): 1.43 (s, ¹J_{PtP}=1296 Hz). FTIR (NaCl, cm⁻¹): 2956 (s), 2929 (s), 2856 (s), 2412 (w), 2117 (s), 2079 (s), 1604 (m), 1566 (w), 1465 (m), 1384 (m), 1286 (m), 1210 (w), 1129 (w), 1092 (m), 1053 (w), 1011 (w), 905 (w), 809 (m), 739 (m).

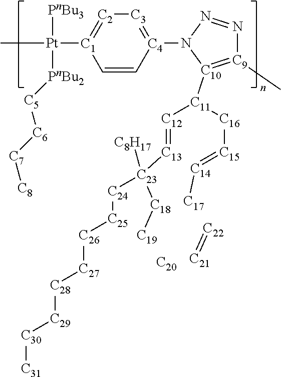

POLY[TRANS-4-AZIDOPHENYL-BIS-TRI-N-BUTYLPHOSPHINE(2-ETHYNYL-9,9-DIOCTYL-9H-FLUORENE)PLATINUM(II)] (4). Monomer 1 (0.247 g, 0.219 mmol) and CuOAc (0.005 g, 20 mol %) were dissolved in DCM (5 mL). The reaction was allowed to progress for 10 d. The solvent was removed in vacuo and the solid was taken up into benzene and filtered to remove CuOAc to yield 0.195 g, 79%. ¹H NMR (500 MHz, CDCl₃, 25° C., δ (ppm)): 7.10-9.45 (aromatic, 11H), 0.41-2.30 (aliphatic, 88H). ³¹P{¹H} NMR (121.4 MHz, CDCl₃, 25° C., δ (ppm)): 9.43 (s), 4.30 (s), 3.79 (s), 2.85 (s), 2.00 (s), 1.12 (s), 4.29 (s, ¹J_{PtP}=1325 Hz), −4.89 (s). FTIR (NaCl, cm⁻¹): 3408 (br, w), 3174 (br, w), 2954 (m), 2926 (s), 2854 (m), 1734 (w), 1608 (w), 1466 (m), 1385 (s), 1263 (m), 1091 (m), 1024 (m), 899 (w), 800 (m), 739 (m).

### Example 1—Synthesis of Metallopolymer Precursors

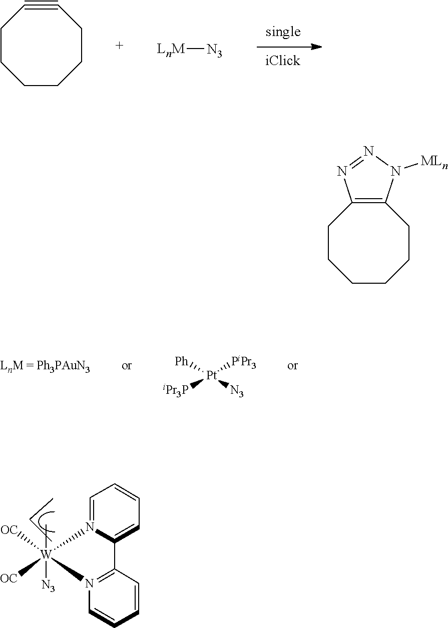

Metallopolymer precursor experiments with commercially available cyclooctyne are conducted. The first metal centers contemplated are three metal-azide complexes from groups 11 (Ph₃ PAuN₃), 10 (trans-(ⁱPr₃P)₂PtPhN₃), and 6 ((bipy)(C₃H₅)W(CO)₂N₃), wherein “bipy” refers to 2,2′-bipyridine. The initial experiments are intended to give an outlook at the breadth of the reaction scope possible across the transition metals.

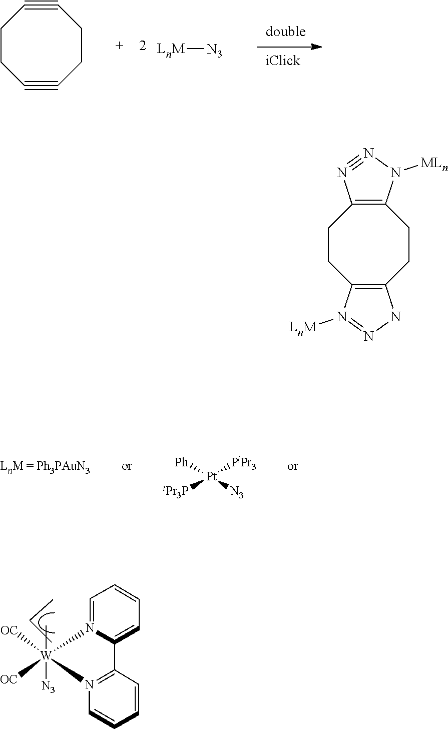

Employing a methodical approach, a second cycloaddition across the commercially available 1,5-cycloctadiyne is employed. However, previously reported conditions showed that a first cycloaddition takes place rapidly, but the second cycloaddition in fact does not occur (Yang, et al., Organometallics 2017, 36, 1352-1357). This surprising result serves as a reminder that subtle steric and electronic factors greatly influence the iClick reaction, thus requiring a more thorough investigation of these reactions and subtle changes to the compounds therein. Due to the alkyne strain of the cyclic dialkyne, the iClick reaction is expected to readily occur.

### Example 2—Synthesis of Metallopolymers

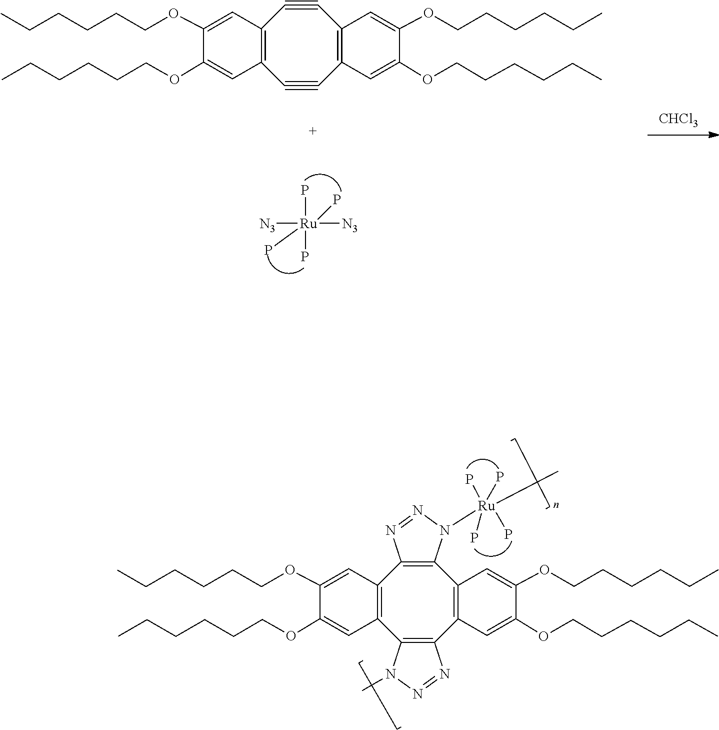

Conjugated Chromophores: The conjugate chromophores are synthesized by using Ru(II) centers, such as the scheme above shows. These complexes can potentially display unique and useful photoredox properties, in addition to giving rise to a new class of photoluminescent materials.

Solubility is often a challenge in metallopolymer synthesis. However, one advantage of the iClick reaction is that it is modular, thus adjusting for solubility challenges can be achieved. Addressing solubility concerns, functionalized and highly soluble cyclooctadiyne is used to produce an advantageously soluble metallopolymer. Cyclooctadiyne is mixed with trans-(depe)₂Ru(N₃)₂ (depe=1,2-bis(diethylphosphino)ethane) resulting in a cascade of iClick reactions to form the Ru-metallopolymer above. Initial characterization will include standard photophysical interrogation (e.g., UV-vis absorbance, or fluorescence), DOSY NMR, GPC, followed by incorporating the material into a solid state OLED.

### Example 3—Metallopolymer Precursors Including NHCs

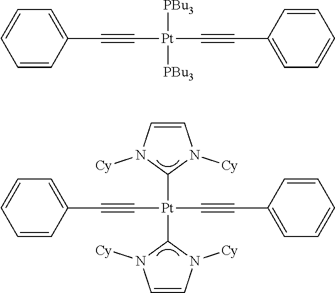

TABLE 1

| | | ε | | Φₚₕ | | | Φₚₕ | |
|---|---|---|---|---|---|---|---|---|
| | λₘₐₓ^{abs} | (M⁻¹cm⁻¹) | λₘₐₓ^{em} | (THF) | τₛₒₗₙ | | (THF) | τ_{solid} |
| Pt-NHC | 278 nm | 33,000 | 444 nm | 0.029 | 1.7 | μs | 0.30 | 9.4 μs |
| Pt-PBu₃ | 324 nm | 24,700 | 435 nm | <0.0006 | 590 | ps | — | — |

Table 1 shows the various differences in photoluminescent properties of two Pt(II) complexes differing only by the type of ligand employed, i.e., a phosphine versus a N-heterocyclic carbene.

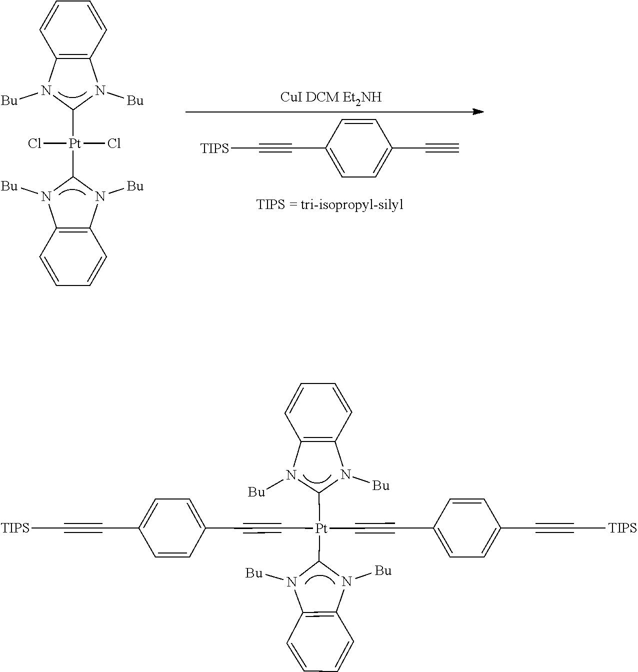

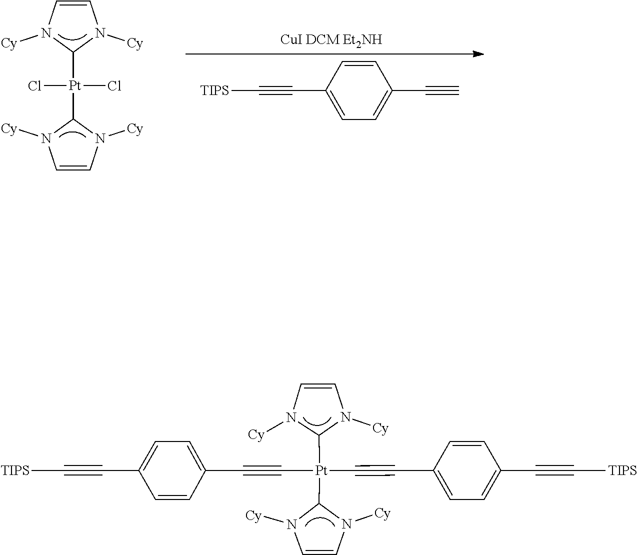

Using a one-pot method, the Pt-NHC precursors that feature two different NHC ligands shown above are synthesized according to previous reports (Winkel et al., Dalton Trans. 2014, 43, 17712-17720). Treating the trans-(NHC)₂PtCl₂ with TIPS mono-protected phenyl acetylide under Hagihara reaction conditions (Blue Phosphorescent trans-N-Heterocyclic Carbene Platinum Acetylides: Dependence on Energy Gap and Conformation, James D. Bullock, Silvano R. Valandro, Amanda N. Sulicz, Charles J. Zeman, Khalil A. Abboud, and Kirk S. Schanze; The Journal of Physical Chemistry A 2019 123 (42), 9069-9078) provides the Pt-acetylides shown above. The TIPS groups are deprotected and treated with a linking diazide under Cu(I) catalytic conditions to initiate iClick polymerization. By retaining the Pt-acetylide, the resulting metallopolymers will exhibit efficient, intense, and tunable phosphorescence.

### Example 4—Synthesis of Metallopolymers Including NHCs

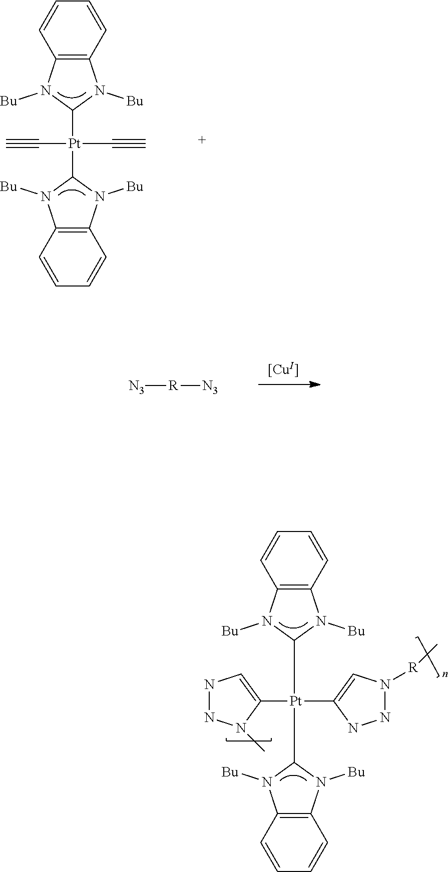

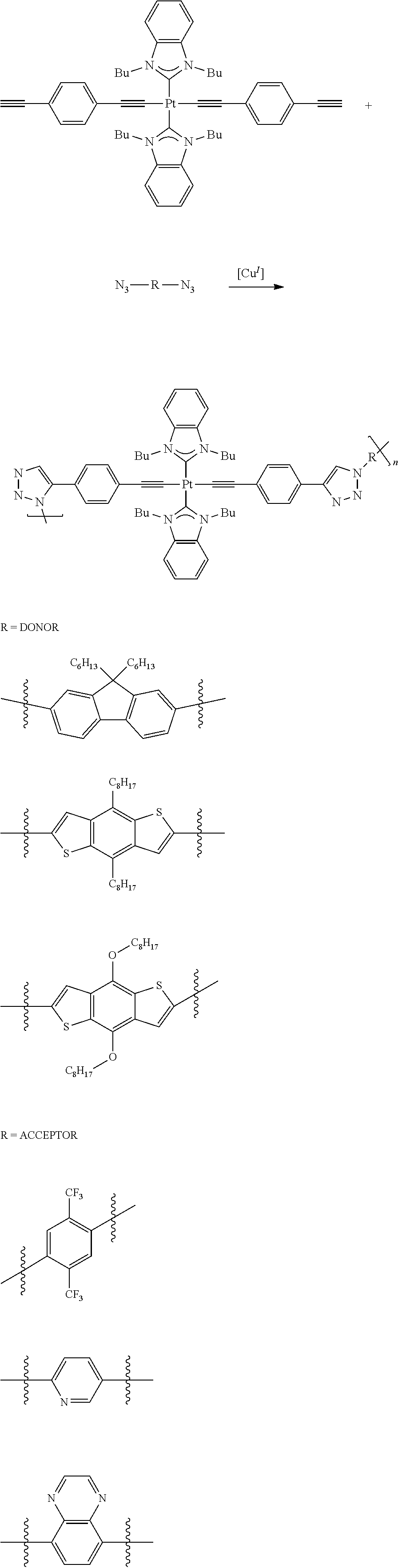

Synthesis of platinum in-chain conjugated metallopolymers via iClick can lead to further interesting photoluminescence properites. In the mild and versatile iClick approach, the metal centers are incorporated into the conjugated polymer backbone and further tune the photophysical properties of the resulting metallopolymer. The Pt-acetylide functionality, important in producing excellent photophysics, is preserved, but at the same time allows the metal centers to be linked via iClick. The Pt-bis-acetylides are coupled with α,ω-diazides in Cu(I) catalyzed cycloadditions shown above. Previous studies on Pt-acetylide based polymers indicate the platinum is bound to the polyyne via a strong σ-bond, thus yielding very robust polymers (Wong, Macromol. Chem. Phys. 2008, 209, 14-24; Wong et al., Macromolecules 2002, 35, 3506-3513). Unique to the iClick approach of this disclosure, the metallopolymers are modified by the choice of the linking diazide unit. The scheme above depicts several choices of linking units that span both donor and acceptor properties. Advantageously, the tunability of the R-group above, including either electron donor species or electron acceptor species, allows for access to a wide array of metallopolymers, and permits the fine-tuning of their optical properties. Depicted in the syntheses are benzimidazole NHC ligands; however, a wide-variety of NHC ligands are plausible. The need for Cu(I) catalyzed reactions can be eliminated in certain cases.

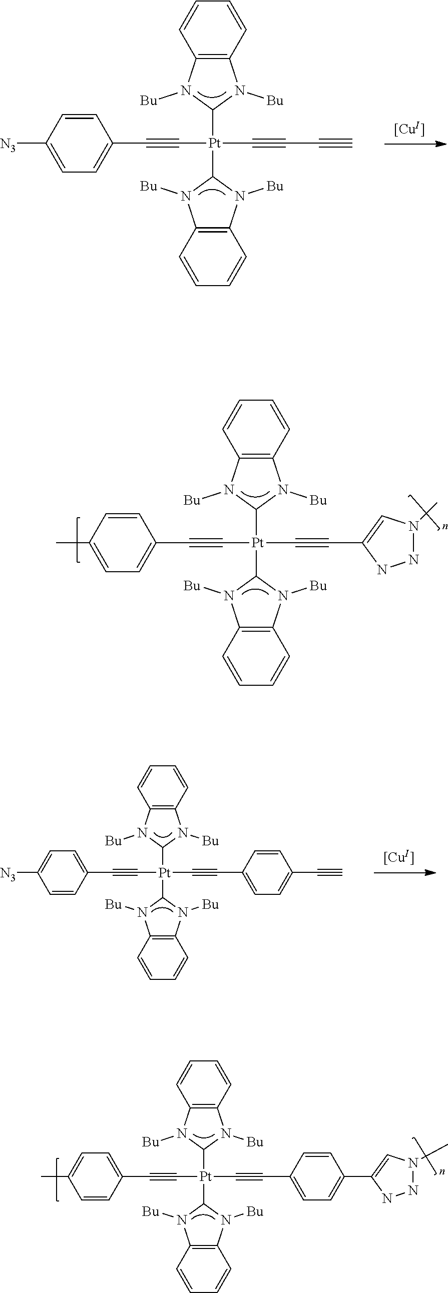

Metallopolymer precursors with both azide and alkyne functionalities: The asymmetric platinum(II) complexes contain a polyyne moiety conjugated to an aryl azide. Previously reported alkyne-azide platinum complexes have been reported and such methods are employed to synthesize the precursors (Schanze et al., J. Am. Chem. Soc. 2007, 129, 8958-8959; Winkel et al., Dalton Trans. 2014, 43, 17712-17720; Wong et al., Macromolecules 2002, 35, 3506-3513). The experiments shown above show a synthetic methodology for the preparation of in-chain metallopolymers of the disclosure. These reactions can be fine-tuned for different desired opto-electric materials properties.

### Example 5—Demonstrated Synthesis of Metallopolymer Precursors

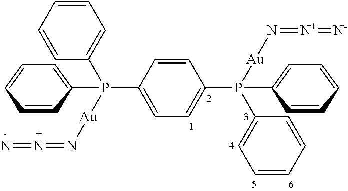

Synthesis of 2-AuN₃: (AuCl)₂(PPh₂(C₆H₄)PPh₂) (182.2 mg, 0.2000 mmol) and silver triflate (51.4 mg, 0.200 mmol), were added into 5 mL of THF and stirred for 5 h. The solution was filtered and NaN₃ (100.0 mg, 1.538 mmol) was added into the mixture with THF:MeOH (3:1 v/v, 12 mL) and stirred at room temperature in the absence of light. After 24 h, the solution was poured in 120 mL of CH₂Cl₂ and washed with water 3×. The organic layer was collected and dried over MgSO₄. The colorless solution was then removed in vacuo, and the precipitate was collected to give 2-AuN₃ as a white powder. 2-AuN₃ was observed to be Cᵢ-symmetric in solid state and was crystallized in the C_{2/}c space group. Crystals were grown through pentane diffusion into a CH₂Cl₂ solution of 2-AuN₃ at −25° C. 81% Yield (150.7 mg, 0.1629 mmol). ¹H NMR (400 MHz, CDCl₃): δ 7.64-7.49 (m, 24H). ¹³C{¹H} NMR (101 MHz, CDCl₃)): δ 134.4 (d, ²J_{CP}=14 Hz, C₄), 134.0 (t, ²J_{CP}=13 Hz, C₁), 133.4 (d, ¹J_{CP}=2 Hz, C₂), 132.6 (m, C₆), 129.6 (d, ³J_{CP}=12 Hz, C₅), 127.2 (d, ¹J_{CP}=63 Hz, C₃). ³¹P{¹H} NMR (162 MHz, CDCl₃): δ 30.9. FTIR (cm−1): 2965 (m), 2918 (m), 2852 (m), 2052 (vs, azide stretch), 1719 (m), 1434 (s), 1272 (m), 1099 (m), 871 (m). Anal. Calcd. for C₃₀H₂₄Au₂N₆P₂: C, 38.98; H, 2.62; N, 9.09. Found: C, 38.75; H, 2.60; N, 8.00. Thus, the preparation of a compound of formula (XI) was demonstrated.

Synthesis of 3-AuPPh₃: 3-AuPPh₃ was prepared as previously described in Whittall et al. J. Organomet. Chem., 1997, 544, 277-283.

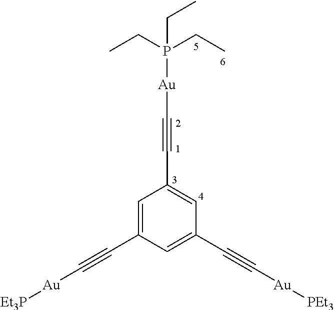

Synthesis of 3-AuPEt₃: Complex 3-AuPEt₃ was synthesized following a modified procedure reported for 1,3,5-C₆H₃(C≡CAu(PPh₃))₃ (3-AuPPh₃). (Whittall et al. J. Organomet. Chem., 1997, 544, 277-283). AuCl(PEt₃) (420.9 mg, 1.200 mmol), 1,3,5-triethynylbenzene (134.6 mg, 0.400 mmol), and sodium methoxide (25 wt. % in methanol, 1 mL) were added into a mixture of THF:MeOH (2:1 v/v, 6 mL). The reaction mixture was stirred at room temperature for 24 h then poured in 200 mL of CH₂Cl₂. The solution was washed with water 3×, dried over MgSO4, filtered, and removed then all volatiles were removed in vacuo. The resulting powder was further washed with toluene to obtain 3-AuPEt₃ as a yellow solid. 81% Yield (0.3236 mmol, 353.5 mg). ¹H NMR (400 MHz, CDCl₃): δ 7.44 (s, 3H, C₄-H), 1.80 (m, 18H, C₅-H), 1.20 (3, 27H, C₆-H). ¹³C{¹H} NMR (101 MHz, CDCl₃)): δ 134.7 (d, ²J_{CP}=140 Hz, C₂), 134.7 (s, C₄), 124.5 (s, C₃), 103.3 (d, ³J_{CP}=27 Hz, C₁), 17.8 (d, ²J_{CP}=33 Hz, C₅), 8.9 (s, C₆). ³¹P{¹H} NMR (162 MHz, CDCl₃): δ 37.7. FTIR (cm⁻¹): 2962 (m), 2929 (m), 2827 (m), 2100 (w; alkyne stretch), 1565 (m), 1452 (m), 1413 (m), 1039 (m), 965 (m), 870 (m). MALDI-TOF-MS: m/z calculated for C₃₀H₄₈Au₃P₃[M+H]⁺ 1093.2039, found 1093.0107. Thus, the preparation of a compound of formula (IXa) was demonstrated.

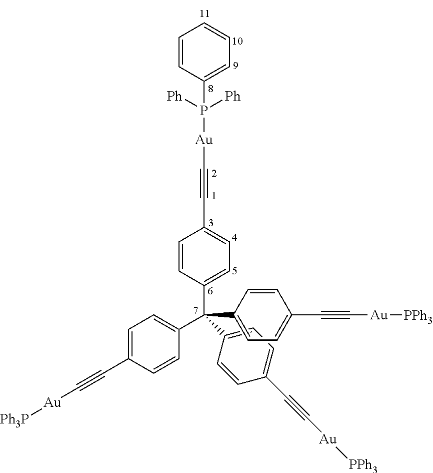

Synthesis of 4-AuPPh₃ Tetrakis(4-((trimethylsilyl)ethynyl)phenyl)methane (141.1 mg, 0.2000 mmol), AuCl(PPh₃) (396.2 mg, 0.8008 mmol), and sodium methoxide (25 wt. % in methanol, 1 mL) were added into a mixture of THF:MeOH (2:1 v/v, 6 mL). The reaction mixture was stirred at room temperature for 24 h then poured into 200 mL of CH₂Cl₂. The solution was washed with water 3×, dried over MgSO₄, filtered, and then all volatiles were removed in vacuo. The powder was further washed with toluene to obtain 4-AuPPh₃ as a yellow solid. Crystals were grown through pentane diffusion into a CH₂Cl₂ solution of 4-AuPPh₃ at −25° C. 71% Yield (0.1424 mmol, 320.5 mg). ¹H NMR (400 MHz, CDCl₃): δ 7.59-7.39 (m, 60H, C₉-H, C₁₀-H and C₁₁-H), 7.36 (d, ³J_{HH}=8.7 Hz, 8H, C₄-H), 7.00 (d, ³J_{HH}=8.7 Hz, 8H, C₅-H). ¹³C{¹H} NMR (101 MHz, CDCl₃)): δ 145.0 (s, C₆), 134.3 (d, ²J_{CP}=14 Hz, C₉), 131.5 (d, ⁴J_{CP}=2 Hz, C₁₁), 131.3 (s, C₄), 130.8 (s, C₅), 129.8 (d, ¹J_{CP}=56 Hz, C₈), 129.1 (d, ³J_{CP}=11 Hz, C₁₀), 122.4 (d, ⁴J_{CP}=3 Hz, C₃), 104.0 (d, ³J_{CP}=27 Hz, C₁), 64.4 (C₇). ³¹P{¹H} NMR (162 MHz, CDCl₃): δ 42.3. FTIR (cm⁻¹): 3058 (m), 2984 (m), 2862 (m), 2119 (w; alkyne stretch), 1501 (m), 1435 (m), 1186 (w), 1099 (m), 1066 (m), 830 (m). Anal. Calcd. for C₁₀₅H₇₆Au₄P₄: C, 56.06; H, 3.41. Found: C, 56.58; H, 3.46; N, 0.03. MALDI-TOF-MS: m/z calculated for C₁₀₅H₇₆Au₄P₄ [M+H]+2250.3667, found 2250.0669. Thus, the preparation of a compound of formula (Xa) was demonstrated.

Synthesis of 3-H: 3-H was prepared as previously described in Cho, K. et al. J. Am. Chem. Soc. 2021, 143, 4100-4106.

Synthesis of 4-H: 4-H was prepared as previously described in Cho, K. et al. J. Am. Chem. Soc. 2021, 143, 4100-4106.

### Example 6—Demonstrated Synthesis of Metallopolymers

Synthesis of 5-AuPEt₃: 2-AuN₃ (160.0 mg, 0.1731 mmol) and 3-AuPEt₃ (126.5 mg, 0.1157 mmol) were weighed out separately and dissolved in CH₂Cl₂ (30 mL for 2-AuN₃; 4 mL for 3-AuPEt₃). The colorless 2-AuN₃ solution was transferred into a pressure tube, followed by slow addition of the yellow 3-AuPEt₃ solution while stirring rigorously. As the 3-AuPEt₃ solution was added, the mixture turned from a transparent yellow solution to an opaque cream color. After addition, the pressure tube was heated at 50° C. for 6 d. During the heating process, precipitate formation was observed. After 6 d, pink solids formed, and a transparent colorless supernatant was observed. The mixture was cooled to room temperature and filtered over coarse filter paper. The resulting pink solid was collected, stirred with 30 mL of CH₂Cl₂ at room temperature for 1 h, and filtered over coarse filter paper. The solid was washed with CH₂Cl₂ (20 mL, 3×) to provide 5-AuPEt₃. (95% Yield, 270.9 mg). Thus, the preparation of a compound of formula (IX) of the disclosure was demonstrated.

Synthesis of 5-AuPPh₃: The same synthesis and workup procedure to that described previously for 5-AuPEt₃ was followed, 3-AuPPh₃ (177.6 mg, 0.1165 mmol) in 6 mL CH₂Cl₂ was slowly added into 2-AuN₃ (161.5 mg, 0.1747 mmol) in 30 mL CH₂Cl₂ to provide 5-AuPPh₃ as a pink powder (76% Yield, 257.7 mg). Thus, the preparation of a compound of formula (IX) of the disclosure was demonstrated.

Synthesis of 6-AuPPh₃: The same synthesis and workup procedure to that described previously for 5-AuPEt₃ was followed, using 2-AuN₃ (160.0 mg, 0.1731 mmol) in 30 mL CH₂Cl₂ and 4-AuPPh₃ (172.9 mg, 0.0864 mmol) in 8 mL CH₂Cl₂ to provide 6-AuPPh₃ as a pink powder (82% Yield, 221.4 mg). Thus, the preparation of a compound of formula (X) of the disclosure was demonstrated.

Synthesis of 5-H: 2-AuN₃ (236.3 mg, 0.2556 mmol) and 3-H (25.6 mg, 0.170 mmol) were separately dissolved in CH₂Cl₂ (2-AuN₃: 40 ml; 3-H: 2 ml), then slowly mixed together in a pressure tube. The slightly yellow transparent solution mixture was heated at 50° C. for 1 d before workup. A color change was observed after heating for 1 h; the solution turned to a milky light yellow color. After 1 d, the solution remained the same color and no solid precipitates were observed. The reaction mixture was cooled to room temperature and the solvent was removed under reduced pressure. A white powder was collected and stirred with 20 mL of CH₂Cl₂ for 1 h at room temperature before being filtered over a coarse filter paper. The solid was later washed with CH₂Cl₂ (20 mL, 3×) to provide 5-H (83% Yield, 216.5 mg). Thus, the preparation of a compound of formula (XII) of the disclosure was demonstrated.

Synthesis of 6-H: The same procedure of the synthesis of 5-H was used for 6-H. 2-AuN₃ (206.5 mg, 0.2234 mmol), and 4-H (46.5 mg, 0.112 mmol) were separately dissolved in CH₂Cl₂ (2-AuN₃: 40 ml; 4-H: 6 ml) and slowly combined in a pressure tube. The tube was heated at 50° C. for 1 d to form a white milky solution. The solution mixture was worked up by slow evaporation of the CH₂Cl₂ solvent. While the mixture was partially wet, solvent exchange was performed with MeOH. After, solvent exchange was performed with perfluorohexane (PFH). Then, the solvents were evaporated to generate a white fluffy powder, which was outgassed at 40° C. for 20 min, followed by heating at 1° C./min to 100° C., which was held for 5 h. to provide 6-H (86% Yield, 217.4 mg). The specific surface areas obtained were 25 m²/g⁻¹ for powder that was solvent exchanged with MeOH and PFH and 29 m²/g⁻¹ for powder that was solvent exchanged only with PFH. Thus, the preparation of a compound of formula (XIII) of the disclosure was demonstrated.

### Example 7—Characterization of Metallopolymers

Thermogravimetric analysis (TGA) was performed on the metallopolymers 5-AuPEt₃, 5-AuPPh₃, 6-AuPPh₃, 5-H, and 6-H The TGA curves showed that 5-AuPEt₃, 5-AuPPh₃, 6-AuPPh₃, 5-H, and 6-H are thermally stable up to 290° C. 5-AuPPh₃, and 6-AuPPh₃ showed a glass transition temperature (Tg) at −32.8° C. and −40.5° C. in the differential scanning calorimetry (DSC) data between −70 to 220° C., which indicates that 5-AuPPh₃, and 6-AuPPh₃ are network polymers.

The porosity of the metallopolymers 5-AuPEt₃, 5-AuPPh₃, 6-AuPPh₃, 5-H, and 6-H was evaluated by examining their physisorption of N₂ and CO₂ gas substrates at different pressures while temperature was held constant. The physisorption of 5-AuPEt₃, 5-AuPPh₃, 6-AuPPh₃, 5-H, and 6-H was evaluated with N₂ at 77 K and these results are reported in Table 1. For 5-AuPPh₃, and 6-AuPPh₃, three samples were prepared using the reaction temperature and time reported in Table 1. For 5-H, two samples were prepared using the reaction temperature and time reported in Table 1.

TABLE 1
Effect of reaction time and reaction temperature on the pore properties

| | | | | Specific | Total | |
|---|---|---|---|---|---|---|
| | | Reaction | | Surface | Pore | |
| | | Temp | Reaction | Area^{a} | Volume^{b} | Yield |
| Polymer | Sample | (° C.) | Time (d) | (m²g⁻¹) | (cm³g⁻¹) | (%) |
| 5-AuPPh₃ | 5-AuPPh₃-1 | rt | 2 | 27 | 0.08 | 63 |
| | 5-AuPPh₃-2 | 50 | 6 | 94 | 0.19 | 76 |
| | 5-AuPPh₃-3 | 100 | 3 | 54 | 0.06 | 42 |
| 6-AuPPh₃ | 6-AuPPh₃-1 | rt | 2 | 44 | 0.13 | 94 |
| | 6-AuPPh₃-2 | 50 | 6 | 85 | 0.12 | 86 |
| | 6-AuPPh₃-3 | 100 | 3 | 47 | 0.08 | 40 |
| 5-AuPEt₃ | 5-AuPEt₃ | 50 | 6 | 30 | 0.07 | 95 |
| 5-H | 5-H-1 | 50 | 1 | 28 | 0.04 | 83 |
| | 5-H-2 | 50 | 6 | 24 | 0.03 | 72 |
| 6-H | 6-H | 50 | 1 | 40 | 0.08 | 86 |

^{a}BET specific surface area in the pressure range of 0.01-0.05 P/P₀ calculated using the BET model;
^{b}Total pore volume at P/P₀ = 0.95.

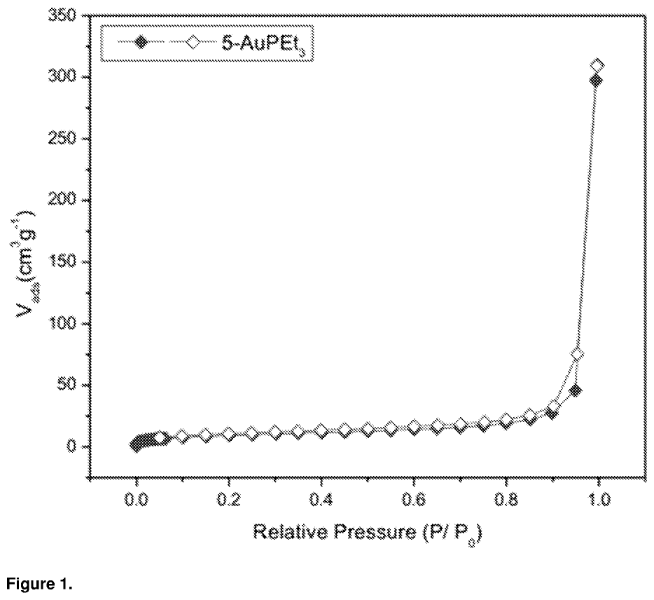

Surface areas of the metallopolymers shown in Table 1, were determined by N₂ adsorption-desorption isotherms. Each of 5-AuPEt₃, 5-AuPPh₃, 6-AuPPh₃, 5-H, and 6-H exhibit surface areas below 100 m²g⁻¹. The surface area and total pore volume were highest when the reaction temp was 50° C. and the reaction time was 6 d. FIG. 1 shows N₂ adsorption-desorption isotherms for 5-AuPEt₃. As shown in FIG. 1, the N₂ adsorption-desorption isotherms increase exponentially with increasing pressure which is indicative of a type III isotherm. Nonporous or macroporous solids display type III isotherms.

The physisorption of 5-AuPEt₃, 5-AuPPh₃, 6-AuPPh₃, 5-H, and 6-H was evaluated with CO₂ at 273 K and 298 K and these results are reported in Table 2.

TABLE 2
CO₂ adsorption properties of metallopolymers

| | | CO₂ Uptake | CO₂ Uptake |
|---|---|---|---|
| Metallopolymer | Sample | (298 K, mg g⁻¹) | (273 K, mg g⁻¹) |
| 5-AuPPh₃ | 5-AuPPh₃-2 | 12.82 | 28.86 |
| 6-AuPPh₃ | 6-AuPPh₃-2 | 14.14 | 29.54 |
| 5-AuPEt₃ | 5-AuPEt₃ | 7.84 | 15.00 |
| 5-H | 5-H-1 | 7.82 | 13.90 |
| 6-H | 6-H | 14.85 | 31.62 |

The polymers 5-AuPPh₃, 6-AuPPh₃, and 6-H demonstrated CO₂ adsorption capacities near 30 and 14 mg g⁻¹ at 273 and 298 K, respectively. The 5-AuPEt₃ and 5-H polymers were measured to be near 15 and 8 mg g⁻¹ at 273 and 298 K, respectively. This is consistent with the results in Table 1, reporting the physisorption of N₂, which indicated that 5-AuPEt₃ and 5-H had a lower surface area than 5-AuPPh₃, 6-AuPPh₃, and 6-H.

1. A metallopolymer comprising a plurality of monomer units,
each monomer unit comprising:
(a) a first transition metal;
(b) a first 1,2,3-triazole substituted at one or more of the 1, 4, and 5 positions and the first 1,2,3-triazole conjugated directly or indirectly to the first transition metal; and
(c) a first N-heterocyclic carbene (NHC) coordinated to the first transition metal.

2. The metallopolymer according to claim 1, wherein each monomer unit further comprises a second transition metal, a second 1,2,3-triazole conjugated directly or indirectly to the first transition metal, a second 1,2,3-triazole conjugated directly or indirectly to the second transition metal, a second NHC coordinated to the first transition metal, or a combination thereof.

3. (canceled)

4. The metallopolymer according to claim 1, wherein the first transition metal is selected from the group of: Au, Pt, Rh, Pd, Ni, Ru, Co, Fe, Ir, W, Re, and Ag.

5. The metallopolymer according to claim 2, wherein the second transition metal is selected from the group of: Au, Pt, Rh, Pd, Ni, Ru, Co, Fe, Ir, W, Re, and Ag.

6. (canceled)

7. (canceled)

8. (canceled)

9. The metallopolymer according to claim 1 having a structure represented by formula (I): 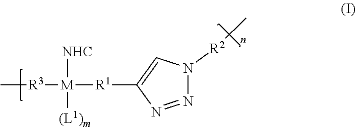
wherein:
NHC is an N-heterocyclic carbene;
R¹ is either a bond or selected from C₁₋₁₀alkyl, C₂₋₆alkynyl, C₀₋₃alkynyl-C₃₋₆cycloalkyl, C₀₋₃alkynyl-Ar¹;
R² is selected from a bond, an electron deficient species, and an electron rich species;
R³ is selected from C₁₋₁₀alkyl, C₂₋₆alkynyl, C₀₋₃alkynyl-C₃₋₆cycloalkyl, C₀₋₃alkynyl-Ar¹, 1,2,3-triazole, C₁₋₁₀alkyl-1,2,3-triazole, C₂₋₆alkynyl-1,2,3-triazole, C₀₋₃alkynyl-C₃₋₆cycloalkyl-1,2,3-triazole, and C₀₋₃alkynyl-Ar¹-1,2,3-triazole;
each L¹ is independently selected from an N-heterocyclic carbene, a phosphine, a phosphite, a phosphonite, a phosphinite, an amine, an amide, an imine, an alkoxy, an aryloxy, an ether, a thioether, an alkylthio, an arylthio, and a five- or six-membered monocyclic group having 1 to 3 ring heteroatoms selected from O, N, and S;
n is 3 or more;
m is 1, 2, or 3;
M is a transition metal; and
each Ar¹ is independently selected from C₆-C₂₂aryl and a 5-12 membered heteroaryl comprising from 1 to 3 ring heteroatoms selected from O, N, and S

10. The metallopolymer according to claim 9, wherein M is selected from: Au, Pt, Rh, Pd, Ni, Ru, Co, Fe, Ir, W, Re, and Ag.

11. (canceled)

12. The metallopolymer according to claim 9, wherein m is 1, L¹ is an NHC, and R¹ is a bond or C₀₋₃alkynyl-Ar¹.

13. (canceled)

14. (canceled)

15. (canceled)

16. The metallopolymer according to claim 9, wherein R³ is selected from 1,2,3-triazole, C₂₋₆alkynyl, C₀₋₃alkynyl-Ar¹, C₂₋₆alkynyl-1,2,3-triazole, and C₀₋₃alkynyl-Ar¹-1,2,3-triazole.

17. (canceled)

18. (canceled)

19. The metallopolymer according to claim 9,
wherein R² is an electron deficient species selected from 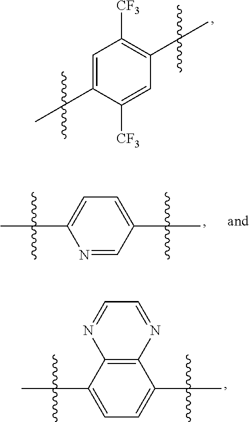 [SMILES: *c1cc(C(F)(F)F)c(*)cc1C(F)(F)F ; *c1ccc(*)nc1 ; *c1ccc(*)c2nccnc12]
or an electron rich species selected from

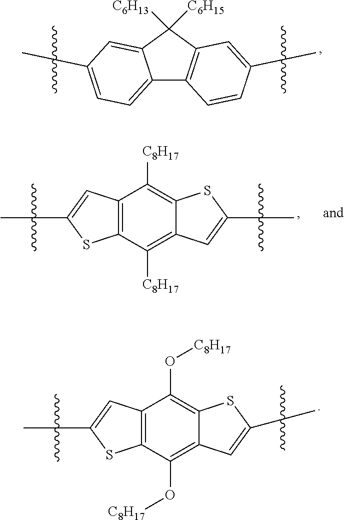

20. (canceled)

21. (canceled)

22. (canceled)

23. The metallopolymer according to claim 1 having a structure represented by formula (IIa) or (IIIb): 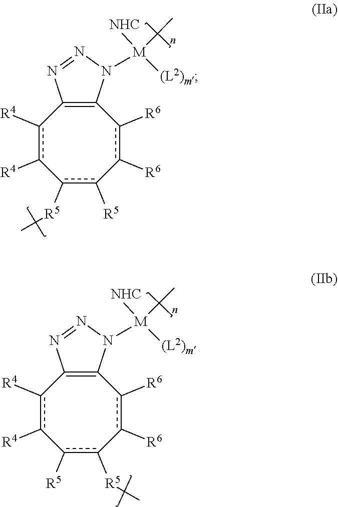
wherein:
each dashed line indicates an optional double bond;
NHC is an N-heterocyclic carbene;
each L² is independently selected from an N-heterocyclic carbene, a phosphine, a phosphite, a phosphonite, a phosphinite, an amine, an amide, an imine, an alkoxy, an aryloxy, an ether, a thioether, an alkylthio, an arylthio, and a five- or six-membered monocyclic group having 1 to 3 ring heteroatoms selected from O, N, or S;
each R⁴ is independently selected from H, C₁₋₁₀alkyl, C₅-C₈cycloalkyl, and Ar², or both R⁴, taken together with the carbon atoms to which they are attached, form an aryl, heteroaryl, or 5-7 membered cycloalkyl, or 5-7 membered heterocycloalkyl comprising from 1 to 3 ring heteroatoms selected from O, N, and S;
each R⁵ is independently selected from H, C₁₋₁₀alkyl, C₅-C₈cycloalkyl, and Ar² or both R⁵, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S;
each R⁶ is independently selected from H, C₁₋₁₀alkyl, C₅-C₈cycloalkyl, and Ar², or both R⁶, taken together with the carbon atoms to which they are attached, form an aryl, heteroaryl, or 5-7 membered cycloalkyl, or 5-7 membered heterocycloalkyl comprising from 1 to 3 ring heteroatoms selected from O, N, and S;
n is 3 or more;
m′ is 1, 2, or 3;
M is a transition metal; and
each Are is independently selected from C₆-CC₂₂aryl and a 5-12 membered heteroaryl comprising from 1 to 3 ring heteroatoms selected from O, N, and S.

24. The metallopolymer according to claim 23, wherein M is selected from: Au, Pt, Rh, Pd, Ni, Ru, Co, Fe, Ir, W, Re, and Ag.

25. (canceled)

26. The metallopolymer according to claim 23, wherein i) both R⁴, taken together with the carbon atoms to which they are attached form an aryl, heteroaryl, 5-7 membered cycloalkyl, or 5-7 membered heterocycloalkyl comprising from 1 to 3 ring heteroatoms selected from O, N, and S, ii) both R⁶, taken together with the carbon atoms to which they are attached form an aryl, heteroaryl, 5-7 membered cycloalkyl, or 5-7 membered heterocycloalkyl comprising from 1 to 3 ring heteroatoms selected from O, N, and S, and/or iii) both R⁵, taken together with the carbon atoms to which they are attached, each independently form an aryl, heteroaryl, 5-7 membered cycloalkyl, or 5-7 membered heterocycloalkyl comprising from 1 to 3 ring heteroatoms selected from O, N, and S.

27. The metallopolymer according to claim 26, wherein i) both R⁴, taken together with the carbon atoms to which they are attached form an aryl, ii) both R⁶, taken together with the carbon atoms to which they are attached form an aryl, and/or iii) both R⁵, taken together with the carbon atoms to which they are attached form a 1,2,3-triazole.

28. (canceled)

29. (canceled)

30. (canceled)

31. (canceled)

32. The metallopolymer according to claim 1 having a structure of formula (IV), (V), (VI), or (VII): 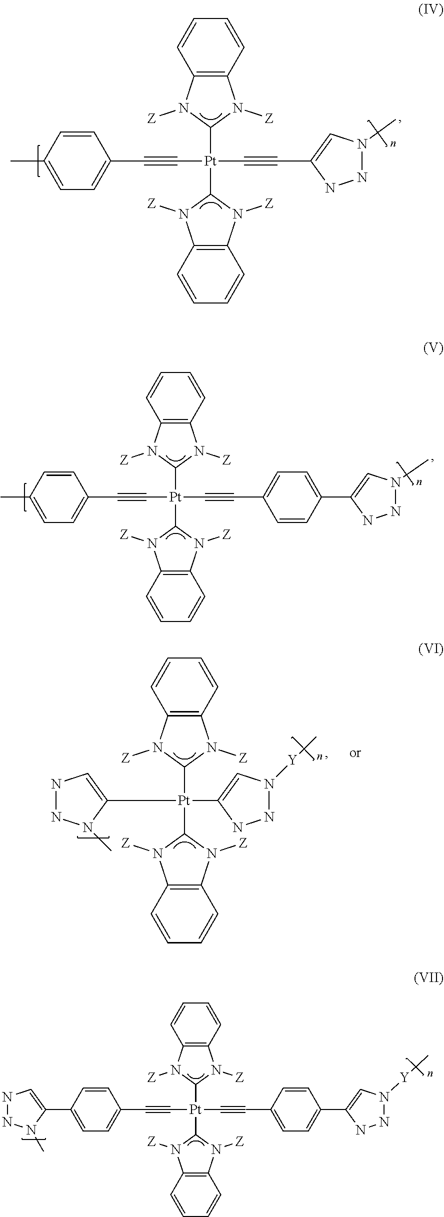
wherein:
n is 10 or more;
each Z is independently selected from C₁₋₂₂alkyl, C₅-C₈cycloalkyl, and Ar⁴;
each Ar⁴ is independently selected from C₆-C₂₂aryl and a 5-12 membered heteroaryl comprising from 1 to 3 ring heteroatoms selected from O, N, and S; and
Y is an electron rich species or an electron deficient species selected from

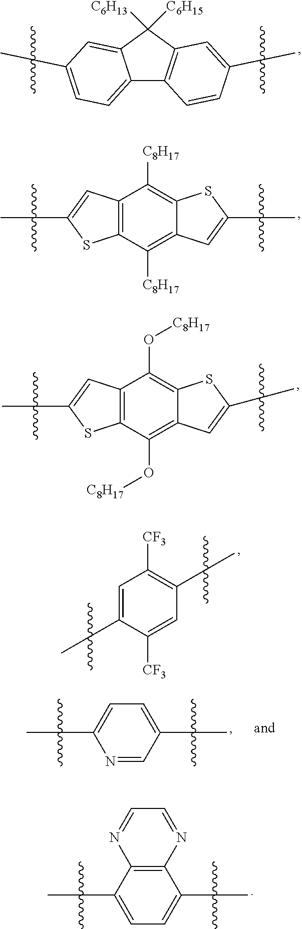

33. (canceled)

34. A method of preparing a metallopolymer according to claim 1, comprising:
admixing an azide-containing compound and an alkyne-containing compound to form the metallopolymer according to claim 1, wherein one or both of the azide-containing compound and the alkyne-containing compound further comprises a transition metal and one or both of the azide-containing compound and the alkyne-containing compound further comprises an N-heterocyclic carbene; and
optionally admixing a catalyst with the azide-containing compound and the alkyne-containing compound, wherein the catalyst comprises copper.

35. (canceled)

36. (canceled)

37. (canceled)

38. (canceled)

39. A method of preparing a metallopolymer according to claim 1, comprising:
admixing a plurality of monomers and a catalyst to form the metallopolymer according to claim 1, wherein each monomer comprises an azide, an alkyne, a transition metal, and an N-heterocyclic carbene; and
optionally admixing a catalyst with the azide-containing compound and the alkyne-containing compound, wherein the catalyst comprises copper.

40. (canceled)

41. (canceled)

42. A metallopolymer having a structure of formula (IIIa) or (IIIb): 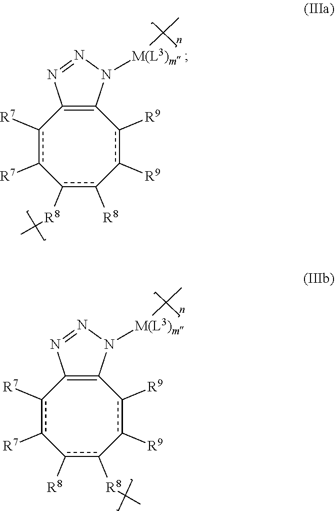
wherein:
the dashed lines indicate optional double bonds;
each L³ is independently selected from a phosphine, a phosphite, a phosphonite, a phosphinite, an amine, an amide, an imine, an alkoxy, an aryloxy, an ether, a thioether, an alkylthio, an arylthio, and a five- or six-membered monocyclic group having 1 to 3 ring heteroatoms selected from O, N, or S;
each R⁷ is independently selected from H, C₁₋₁₀alkyl, C₅-C₈cycloalkyl, and Ar³, or both R⁷, taken together with the carbon atoms to which they are attached, form an aryl, heteroaryl, 5-7 membered cycloalkyl, or 5-7 membered heterocycloalkyl comprising from 1 to 3 ring heteroatoms selected from O, N, and S;
each R⁸ is independently selected from H, C₁₋₁₀alkyl, C₅-C₈cycloalkyl, and Ar³, or both R⁸, taken together with the carbon atoms to which they are attached, form an aryl, heteroaryl, or 5-7 membered cycloalkyl, or 5-7 membered heterocycloalkyl comprising from 1 to 3 ring heteroatoms selected from O, N, and S;
each R⁹ is independently selected from H, C₁₋₁₀alkyl, C₅-C₈cycloalkyl, and Ar³, or both R⁹, taken together with the carbon atoms to which they are attached, form an aryl, heteroaryl, or 5-7 membered cycloalkyl, or 5-7 membered heterocycloalkyl comprising from 1 to 3 ring heteroatoms selected from O, N, and S;
n is 10 or more;
m″ is 1, 2, 3, or 4;
M is a transition metal; and
each Ar³ is independently selected from C₆-C₂₂aryl and a 5-12 membered heteroaryl comprising from 1 to 3 ring heteroatoms selected from O, N, and S.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. A method of preparing a metallopolymer according to claim 42, comprising:
admixing an azide-containing compound and an alkyne-containing compound to form the metallopolymer according to claim 42, wherein one or both of the azide-containing compound and alkyne-containing compound further comprise a transition metal.

56. (canceled)

57. (canceled)

58. (canceled)

59. (canceled)

60. A metallopolymer having a structure of formula (IX), (X), (XII), or (XIII): 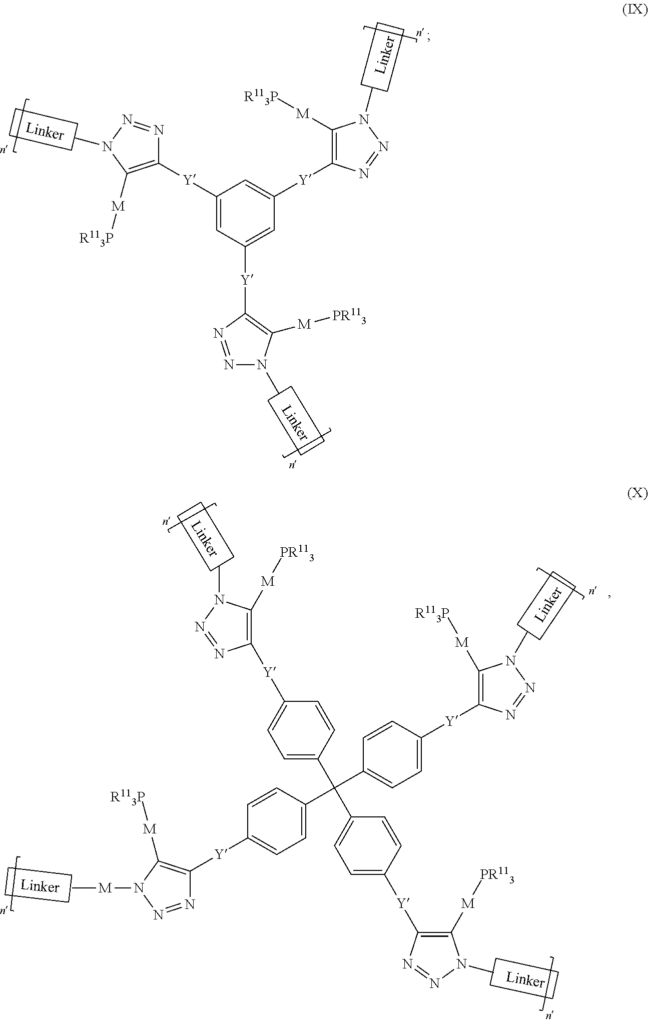 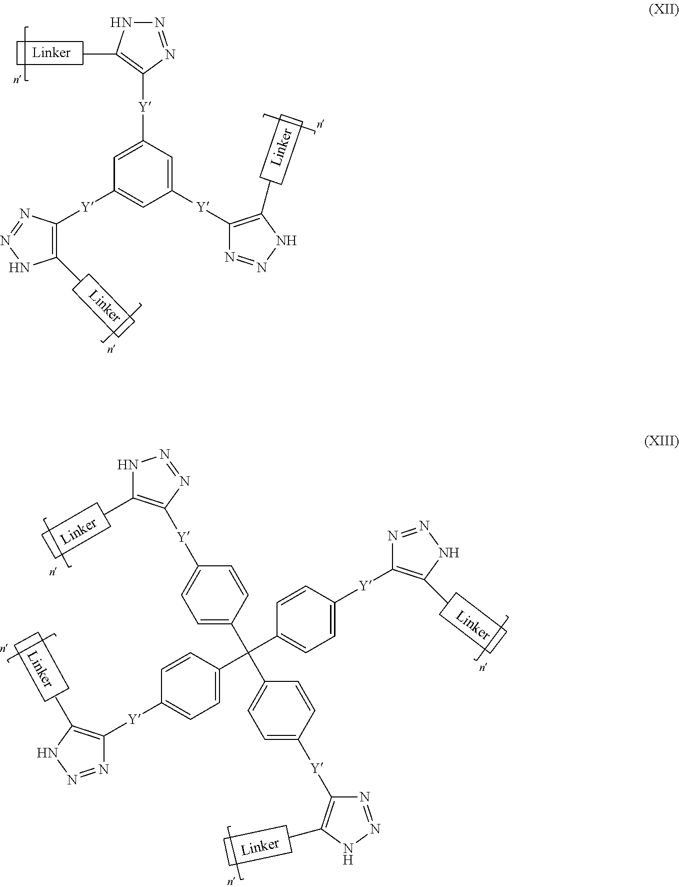
wherein:
each [symbol] has a structure: 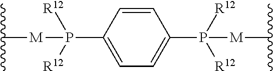
each M is a transition metal;
each R¹¹ is independently selected from H, C₁₋₁₀alkyl, C₅-C₈cycloalkyl, Ar³, heteroaryl, and 5-7 membered heterocycloalkyl comprising from 1 to 3 ring heteroatoms selected from O, N, and S;
each R¹² is independently selected from H, C₁₋₁₀alkyl, C₅-C₈cycloalkyl, Ar³, and 5-7 membered heterocycloalkyl comprising from 1 to 3 ring heteroatoms selected from O, N, and S;
each n′ is an integer;
each Y′ is absent or independently selected from C₁₋₁₀alkyl and Ar³; and
each Ar³ is independently selected from C₆-C₂₂aryl and a 5-12 membered heteroaryl comprising from 1 to 3 ring heteroatoms selected from O, N, and S.

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. A method of preparing a metallopolymer according to claim 60, the method comprising:
admixing a compound of formula (IXa), (Xa), (XIIa), or (XIIIa) with a compound of formula (XI): 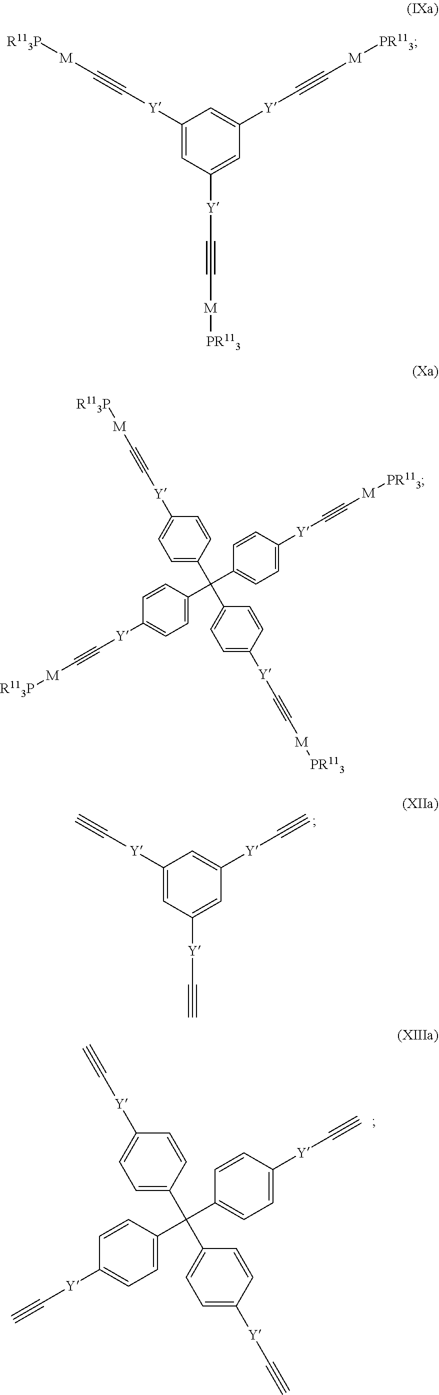 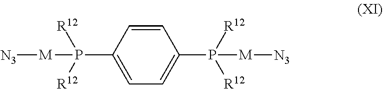
wherein
each M is a transition metal;
each R¹¹ is independently selected from H, C₁₋₁₀alkyl, C₅-C₈cycloalkyl, Ar³, heteroaryl, and 5-7 membered heterocycloalkyl comprising from 1 to 3 ring heteroatoms selected from O, N, and S;
each R¹² is independently selected from H, C₁₋₁₀alkyl, C₅-C₈cycloalkyl, Ar³, and 5-7 membered heterocycloalkyl comprising from 1 to 3 ring heteroatoms selected from O, N, and S;
each Y′ is absent or independently selected from C₁₋₁₀alkyl and Ar³; and
each Ar³ is independently selected from C₆-C₂₂aryl and a 5-12 membered heteroaryl comprising from 1 to 3 ring heteroatoms selected from O, N, and S.

82. (canceled)

83. (canceled)

84. (canceled)

85. (canceled)

86. (canceled)

87. (canceled)

88. (canceled)

89. (canceled)

90. (canceled)
